(19) United States
(12) Patent Application Publication
(10) Pub. No.: US 2012/0122580 A1
(43) Pub. Date: May 17, 2012

(54) GAME DEVICE, GAME DEVICE CONTROL METHOD AND INFORMATION RECORDING MEDIUM STORING PROGRAM

(75) Inventor: Yuichi Asami, Minato-ku (JP)

(73) Assignee: KONAMI DIGITAL ENTERTAINMENT CO., LTD., Tokyo (JP)

(21) Appl. No.: 13/285,948

(22) Filed: Oct. 31, 2011

(30) Foreign Application Priority Data
Nov. 16, 2010 (JP) 2010-256342

(51) Int. Cl. A63F 13/06; A63F 9/24

(52) U.S. Cl. 463/37; 463/43

(57) ABSTRACT

A game device includes a memory unit, a display unit, a detecting unit, and a noticing unit. The memory unit stores plural pieces of task information each indicating a timing at which a player should give an operation and a position where the operation should be given. The display unit displays each stored task information in the screen. The detecting unit detects a position where the player gives an operation. The noticing unit gives a notice to the player when the detected position where the player gives an operation does not match any one of the positions indicated in the plural pieces of task information, and prompts the player not to operate the position that should not have been be operated.

### CROSS-REFERENCE TO RELATED APPLICATION

This application claims the benefit of Japanese Patent Application No. 2010-256342, filed on Nov. 16, 2010, the entire disclosure of which is incorporated by reference herein.

### TECHNICAL FIELD

This application relates generally to a game device that is capable of prompting a player not to operate a position that should not be operated, a control method and a non-transitory computer-readable information recording medium storing a program both for the game device.

### BACKGROUND ART

A music game is conventionally known which allows a player to operate a button or a foot switch in accordance with a rhythm of a music and a display timing of a screen. According to such a music game, for example, predetermined objects sequentially appear from the bottom of a screen in synchronization with a played music and go upward in the screen. Conversely, a player depresses a foot switch or a button indicating back and forth and right and left at a timing at which those objects reach a determination line that is a determination basis. If the timing at which the button is depressed matches the reaching timing, i.e., if it is determined that a time at which an operation is input is included within a predetermined time range, a score is added.

The length of the predetermined time range indicates an allowable level of an operation inputting timing, and the shorter the length of the predetermined time range is, the more the difficulty of the game increases. Likewise, the longer the length of the predetermined time range is, the more the difficulty of the game decreases. Unexamined Japanese Patent Application KOKAI Publication No. 2010-220941, etc., discloses such a game device.

According to such a game device, the player must not step on the front-right, rear-right, front-left, and rear-left portions of the foot switch relative to a home position. That is, the front-right, rear-right, front-left, and rear-left portions of the foot switch relative to a home position are not used as positions that the player should depress. In the present specification, the front-right, rear-right, front-left, and rear-left positions relative to the home position are hereinafter referred to as “positions that should not be operated”. Conversely, when a task that the player should depress the “right” portion of the foot switch is given, the player should not operate the “front” portion of the foot switch. However, the “front” portion of the foot switch may be a portion of the foot switch that should be depressed according to another task. Hence, when a task that the player should depress the “right” portion of the foot switch is given, the player should not operate the “front” portion of the foot switch, but the “front” portion thereof may become a portion that the player should operate in another timing. Accordingly, the “front” portion of the foot switch does not become the “position that should not be operated”, but may be a “position that should be operated”.

At a moment other than the reaching timing, when the player operates the position that should not be operated, i.e., depresses an oblique position, it does not affect the score. Moreover, at a reaching timing of a task that the player should depress the “right” portion of the foot switch, if both right portion of the foot switch (the position that should be operated) and front-right portion thereof (the position that should not be operated) are simultaneously operated, such an operation is accepted as a successful operation. However, a mistake often occurs after such an operation.

Therefore, there is a demand for a technology which enables the player to grasp the fact that the player depressed the position that should not be operated, and which assists the player to depress a correct button at a next timing.

The present invention is made in order to overcome the above-explained technical issue, and it is an object of the present invention to provide a game device that is capable of prompting a player not to give an operation to a position that should not be operated, a control method and a non-transitory computer-readable information recording medium storing a program both for the game device.

### SUMMARY

A game device according to a first aspect of the present invention includes a memory unit, a display unit, a detecting unit, and a noticing unit, and is configured as follows.

The memory unit stores a plurality of data of task information each indicating a timing at which a player should give an operation and a position where the operation should be given.

The task information indicates a kind of a button that should be depressed in accordance with music and a timing at which such a depression should be given in a dancing game for example.

The display unit displays each of the plurality of data of stored task information on a screen at least at a timing indicated in the task information.

As explained above, the task information is stored in the memory unit. The display unit presents the kind of a button that should be depressed on the mat-type controller, etc., at a timing indicated by the task information.

The display unit may start displaying the position that should be operated at a time before a timing indicated by the task information. Moreover, the display unit may keep displaying the position that should be operated up to a time after the timing indicated in a tasked time.

The detecting unit detects whether or not an operation is given by the player and detects, when the operation is given, a position where the operation is given in the operation surface.

For example, when the player depresses various buttons prepared on the mat-type controller, etc., of the game device, the inputting of an operation is detected. The detail of the operation given by the player may be detected by various sensors, such as a touch sensor, a pressure sensor, and an infrared sensor.

The noticing unit gives a notice to the player when it is detected that the player gives the operation and the detected position where the operation is given does not match any one of the positions indicated by the plurality of data of task information.

The positions indicated by the plurality of data of task information are positions corresponding to buttons located back and forth and right and left. Hence, when the detected position does not match any one of the positions indicated by the plurality of data of information, such a position is the position that should not be operated. When the button in the oblique direction is depressed, since the position of such a button does not match any one of the positions indicated by the plurality of data of task information, the noticing unit presents a notice to the player. Regarding how to present a notice, in addition to displaying of a notice message on a screen, such a notice may be presented by sound.

The detail of the operation input indicated by the plurality of task information is not limited to the above example, and is arbitrary.

According to the game device of the present invention, the player is capable of knowing that the player depresses a position that is not indicated by the task information, so that the player can prepare giving a correct inputting at a next timing.

The game device of the present invention can be also configured as follows.

The position where the operation should be given is in an operation surface, and a scoring unit obtains a score of the player based on whether or not it is detected that the player gives the operation at the timing indicated by the task information and on whether or not the detected position where the operation is given matches a position indicated in the task information.

The operation surface is a surface subjected to an operation given by the player at the time of executing a game. An example of operation surface is a mat face of a mat-type controller, a surface of a controller that is a type of being held by a hand, or a touch panel of a portable terminal. A plurality of buttons, keys, foot switches, etc., may be disposed in the operation surface. When the pluralities of buttons are disposed in the operation surface, each position of the plurality of depressed buttons is detected as a position where the player gives an operation.

Moreover, a turn table or a plurality of buttons may be disposed on the operation surface. In this case, the operation surface is a surface of a controller.

Furthermore, the operation surface may be a surface of a controller formed in a shape of a musical instrument like a guitar. For example, when the operation surface is in a shape of a guitar, the position where the operation should be given is a position where strings are located in the guitar.

According to a game device which picks up an image of the player using a camera and which detects a motion of the player in order to instruct the player to input an operation, the player gives an instruction operation through a virtual controller. In this case, the operation surface is a virtual surface located ahead of the player.

The task information indicates, for example, an operation input of depressing a button located back and forth and right and left. In this case, as viewed from a center home position, a button in an oblique direction is not indicated as a position indicated in the task information. Hence, the button in the oblique direction is a position that should not be operated.

The scoring unit determines whether or not the operation given by the player is successful based on the detail of the operation given by the player and detected by the detecting unit. First, the scoring unit determines whether or not a time at which the player gives an operation matches a timing indicated by the task information. Next, the scoring unit determines the position where the player gives the operation. For example, the scoring unit determines whether or not the kind of the button depressed by the player on the controller matches the kind of the button indicated by the task information. In this case, when the kind of the depressed button matches the kind of the button indicated by the task information, it is determined that the position matches. When the time at which the operation is given is within a predetermined time including the timing indicated by the task information, the scoring unit may determine that the timing matches. That is, a term “matching” means that the player gives an operation within a predetermined time including the timing indicated by the task information and the kind of the button indicated by the task information is consistent with the kind of the depressed button.

When the timing in the task information matches the operation timing and the position in the task information matches the operation position, the scoring unit determines that the inputting of an operation given by the player is successful. Moreover, when the timing does not match, the scoring unit determines that the inputting of an operation given by the player is unsuccessful. Furthermore, when the position does not match even if the timing matches, the scoring unit determines that the inputting of an operation given by the player is unsuccessful.

The game device of the present invention can be also configured as follows.

When it is detected that the player gives an operation in a time period other than the timing indicated by the task information and the detected position where the operation is given does not match any one of the positions indicated in the plurality of data of task information, the noticing unit presents notice information to the player in order to give the notice to the player, the notice information corresponding to the detected position.

The time period other than the timing indicated by the task information is a timing at which no operation input should be given. That is, such a time period is not subjected to a scoring determination. For example, when a button obliquely frontward of the center home position is depressed in a time period that is not subjected to the scoring determination, the noticing unit gives a notice “excessively forward!” and when a button obliquely rearward is depressed, the noticing unit gives a notice “excessively rearward!”.

According to the game device of the present invention, if notices, such as “excessively forward!” and “excessively rearward!” are presented as explained above, it is possible to prompt the player to correct the improper inputting in the back-and-forth direction.

Moreover, the game device of the present invention can also be configured as follows.

Where the noticing unit presents the notice information to the player in order to give the notice to the player, the notice information corresponding to a relative positional relationship between the detected position and a position which is indicated by a most recent task information which has already past as indicated by the timing.

For example, if an obliquely leftward button relative to the center home position is depressed when the front button should be depressed in the most recent task information among the buttons located back and forth and right and left, the noticing unit gives a notice “excessively leftward!” and if an obliquely rightward button relative to the home position is depressed, the noticing unit gives a notice “excessively rightward!”.

The detail of the operation input indicated by the plurality of data of task information is not limited to the above example, and is arbitrary.

According to the game device of the present invention, when notices, such as “excessively rightward!” and “excessively leftward!”, are presented as explained above in addition to the notices, such as “excessively forward!” and “excessively rearward!”, the player can grasp a relationship between the position indicated by the most recent task information and the position that the player himself/herself depresses. Accordingly, the player can prepare giving a correct inputting at a next timing.

Furthermore, the game device of the present invention can be configured as follows.

When the detected position and the position which is indicated by the most recent task information which has already post as indicated by the timing,

(a) adjoin to each other, the noticing unit presents the notice information to the player in order to give the notice to the player, the notice information corresponding to a relative positional relationship of the detected position to the position indicated by the most recent task information, and

(b) do not adjoin to each other, the noticing unit presents the notice information to the player in order to give the notice to the player, the notice information corresponding to the detected position.

For example, it is presumed that an obliquely rightward button relative to the home position is depressed. When the front button should be depressed in the most recent task information among the buttons located back and forth and right and left, it corresponds to the case (a), and the noticing unit gives a notice “excessively rightward!”. Moreover, when the right button should be depressed, it corresponds to the case (b), and the noticing unit gives a notice “excessively forward !”.

Conversely, when the rear button or the left button should be depressed, it corresponds to the case (b), and the noticing unit gives a notice “excessively forward!”.

The detail of the operation input indicated by the plurality of data of task information is not limited to the above example, and is arbitrary.

According to the game device of the present invention, the detail of the notice is changed in accordance with a distance between the position indicated by the most recent task information and the position depressed by the player. Hence, the player can finely adjust the position of inputting an operation.

Still further, the game device of the present invention can be configured as follows.

When a number of positions which adjoin to the detected position, is indicated by the most recent task information which has already part as indicated by the timing is a plural number, the noticing unit selects any one of the positions, and presents the notice information to the player in order to give the notice to the player, the notice information corresponding to the relative positional relationship of the detected position to the selected position.

More specifically, when it is required to depress a plurality of buttons at the same timing, the game device of the present invention selects any one of the buttons, and presents a notice based on a positional relationship between the selected button and the depressed button. For example, when the “front” and “right” buttons should be depressed simultaneously, if the front-right button is depressed, a notice message “excessively rightward!” or “excessively forward!” is displayed. The selection of the button may be at random. Moreover, when the button is selected, a preference to either one of “right and left” and “back and forth” may be given in advance.

According to the game device of the present invention, it is possible to prompt the player to correct improper positioning even if the plurality of buttons should be depressed.

The game device of the present invention can be also configured as follows.

The noticing unit displays the notice information on the screen in order to give the notice to the player.

For example, the noticing unit gives a notice by displaying notice information, such as “excessively leftward !”, “excessively rightward !”, “excessively forward!” and “excessively rearward!”.

According to the game device of the present invention, the notice information is displayed on the screen, so that the player can visually recognize the notice information easily.

The game device of the present invention can also be configured as follows.

The operation surface is provided with a plurality of detectors which are disposed on the operation surface and which detect a depression given by the player.

The positions indicated by the plurality of data of task information are all any positions of the plurality of detectors.

The positions of the plurality of detectors include positions which are not the positions indicated by the plurality of data of task information.

When any one of the plurality of detectors is depressed, the detecting unit detects a depressed timing and the position of the depressed detector as the timing at which the operation is given and the position where the operation is given.

For example, the operation surface is the mat face of a mat-type controller, and a detector is a button provided on the mat face of the mat-type controller. The positions indicated by the plurality of task information are respective buttons located back and forth and right and left. The button in the oblique direction relative to the center home position does not match a position indicated by the task information.

When any one of the buttons is depressed, the detecting unit detects the depressed timing and the kind of the depressed button as the timing at which the operation is given and the position where the operation is given.

The mat-type controller is a floor type. By using the mat-type controller, the player depresses the button through a stepping motion, and enjoys the game.

According to the game device of the present invention, the player can enjoy, for example, a dancing game using the floor-type controller.

The game device of the present invention can also be configured as follows.

The operation surface is a touch panel that detects a depression given by the player.

The detecting unit detects a timing at which the depression is given to the touch panel and a position where the depression is given as the timing at which the operation is given and the position where the operation is given.

For example, the operation surface is a touch panel of a portable terminal. Moreover, the detecting unit may be regions in the touch panel set as a plurality of buttons. When a position corresponding to each position is depressed, the timing at which the depression is given is taken as the timing at which the operation is given. The position where the operation is given is indicated by the kind of the button including the depressed position.

According to the game device of the present invention, the player can enjoy, for example, a dancing game using a portable terminal.

A control method according to another aspect of the present invention is executed by a game device that includes a memory unit to store a plurality of data of task information each indicating a timing at which a player should give an operation and a position where the operation should be given, the method comprising:

displaying each of the plurality of data of stored task information on a screen at least at the timing indicated in the task information;

detecting whether or not an operation is given by the player and also to detect, when the operation is given, a position where the operation is given; and

giving a notice to the player when it is detected that the player gives the operation and the detected position where the operation is given does not match any one of the positions indicated by the plurality of data of task information.

According to the present invention, the player can know that the position that should not be depressed is depressed. Hence, the player can prepare giving a correct inputting at a next timing.

A non-transitory computer-readable information recording medium according to the other aspect of the present invention stores a program that causes a computer to function as a memory unit, a display unit, a detecting unit, and a noticing unit.

The memory unit stores a plurality of data of task information each indicating a timing at which a player should give an operation and a position where the operation should be given.

The display unit displays each of the plurality of data of stored task information on a screen at least at a timing indicated in the task information.

The detecting unit detects whether or not an operation is given by the player and which detects, when the operation is given, a position where the operation is given.

The noticing unit gives a notice to the player when it is detected that the player gives the operation and the detected position where the operation is given does not match any one of the positions indicated by the plurality of data of task information.

According to the present invention, the computer can function as the game device that operates as explained above.

The program of the present invention can be recorded in a non-transitory computer readable information recording medium, such as a compact disc, a flexible disc, a hard disk, a magneto-optical disk, a digital video disk, a magnetic tape, or a semiconductor memory.

The program can be separately distributed and sold over a computer communication network from a computer that runs the program. Moreover, the information recording medium can be distributed and sold from such a computer.

According to the present invention, there are provided a game device that is capable of prompting a player not to operate a position that should not be operated, a control method and a non-transitory computer-readable information recording medium storing a program both for the game device.

### BRIEF DESCRIPTION OF THE DRAWINGS

A more complete understanding of this application can be obtained when the following detailed description is considered in conjunction with the following drawings, in which:

FIG. 1 is an exemplary diagram showing a general configuration of a typical information processing device that realizes a game device according to first to sixth embodiments of the present invention;

FIG. 2 is an exemplary diagram showing a general configuration of a mat-type controller connectable to the game device according to the first to sixth embodiments;

FIG. 3 is a diagram for explaining a display screen of the game device according to the first to sixth embodiments;

FIG. 4 is an explanatory diagram showing how data is stored in a RAM;

FIG. 5 is a block diagram showing a configuration of a game device according to first to seventh embodiments of the present invention;

FIG. 6A is a diagram showing an illustrative position stepped on by a player;

FIG. 6B is a diagram showing an illustrative screen displayed;

FIG. 7 is a diagram showing a time range subjected to a score determination when task data shown in FIG. 4 is used;

FIG. 8A is a diagram showing an illustrative position of a mat-type controller stepped on by a player according to the first embodiment;

FIG. 8B is a diagram showing an illustrative screen displayed according to the first embodiment;

FIG. 9 is a flowchart showing a game control process executed by the game device according to the first to seventh embodiments;

FIG. 10 is a flowchart showing a notice presenting process executed by the game device according to the first embodiment;

FIG. 11 is a flowchart showing a scoring process executed by the game device according to the first to seventh embodiments;

FIG. 12A is a diagram showing an illustrative position of a mat-type controller stepped on by a player according to the second embodiment;

FIG. 12B is a diagram showing an illustrative position of the mat-type controller stepped on by the player according to the second embodiment;

FIG. 12C is a diagram showing an illustrative screen displayed according to the second embodiment;

FIG. 12D is a diagram showing an illustrative position of the mat-type controller stepped on by the player according to the second embodiment;

FIG. 12E is a diagram showing an illustrative position of the mat-type controller stepped on by the player according to the second embodiment;

FIG. 12F is a diagram showing an illustrative screen displayed according to the second embodiment;

FIG. 13 is a flowchart showing a notice presenting process executed by the game device according to the second embodiment;

FIG. 14A is a diagram showing an illustrative position of the mat-type controller stepped on by a player according to the third embodiment;

FIG. 14B is a diagram showing an illustrative position of the mat-type controller stepped on by the player according to the third embodiment;

FIG. 14C is a diagram showing an illustrative screen displayed according to the third embodiment;

FIG. 14D is a diagram showing an illustrative position of the mat-type controller stepped on by the player according to the third embodiment;

FIG. 14E is a diagram showing an illustrative position of the mat-type controller stepped on by the player according to the third embodiment;

FIG. 14F is a diagram showing an illustrative screen displayed according to the third embodiment;

FIG. 15 is a flowchart showing a notice presenting process executed by the game device according to the third embodiment;

FIG. 16A is a diagram showing an illustrative position of the mat-type controller stepped on by a player according to the fourth embodiment;

FIG. 16B is a diagram showing an illustrative screen displayed according to the fourth embodiment;

FIG. 16C is a diagram showing an illustrative position of the mat-type controller stepped on by the player according to the fourth embodiment;

FIG. 16D is a diagram showing an illustrative screen displayed according to the fourth embodiment;

FIG. 16E is a diagram showing an illustrative position of the mat-type controller stepped on by the player according to the fourth embodiment;

FIG. 16F is a diagram showing an illustrative screen displayed according to the fourth embodiment;

FIG. 17 is a flowchart showing a notice presenting process executed by the game device according to the fourth embodiment;

FIG. 18A is a diagram showing an illustrative position of the mat-type controller stepped on by a player according to the fifth embodiment;

FIG. 18B is a diagram showing an illustrative screen displayed according to the fifth embodiment;

FIG. 18C is a diagram showing an illustrative position of the mat-type controller stepped on by the player according to the fifth embodiment;

FIG. 18D is a diagram showing an illustrative screen displayed according to the fifth embodiment;

FIG. 19 is a flowchart showing a notice presenting process executed by the game device according to the fifth embodiment;

FIG. 20 is an explanatory diagram showing how data is stored in a RAM;

FIG. 21A is a diagram showing an illustrative position of the mat-type controller stepped on by a player according to the sixth embodiment;

FIG. 21B is a diagram showing an illustrative screen displayed according to the sixth embodiment;

FIG. 22A is a diagram showing an illustrative position of the mat-type controller stepped on by a player according to the sixth embodiment;

FIG. 22B is a diagram showing an illustrative screen displayed according to the sixth embodiment;

FIG. 22C is a diagram showing an illustrative screen displayed according to the sixth embodiment;

FIG. 23A is a flowchart showing a notice presenting process executed by the game device according to the sixth embodiment;

FIG. 23B is a flowchart showing the notice presenting process executed by the game device according to the sixth embodiment; and

FIG. 24 is a diagram for explaining a display screen of the game device according to the seventh embodiment.

### DETAILED DESCRIPTION

Embodiments of the present invention will be described below. For ease of understanding, the embodiments that realize the present invention using an information processing device for games will be explained, but the embodiments described below are provided to give an explanation, and are not to limit the scope of the present invention. Therefore, those skilled in the art can adopt embodiments in which some or all of the structural elements are replaced with respective equivalents, and it should be understood that such embodiments are also included within the scope and spirit of the present invention.

### First Embodiment

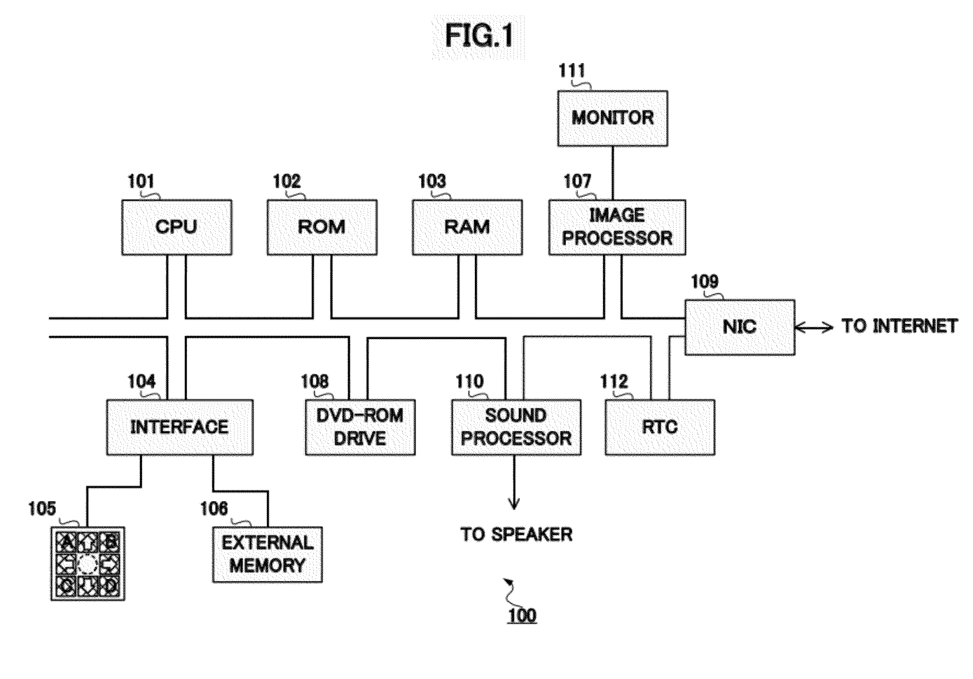

FIG. 1 is an exemplary diagram showing a general configuration of a typical information processing device functioning as a game device of the present embodiment by running a program. An explanation will now be given with reference to this drawing.

An information processing device 100 includes a Central Processing Unit (CPU) 101, a Read Only Memory (ROM) 102, a Random Access Memory (RAM) 103, an interface 104, a mat-type controller 105, an external memory 106, an image processor 107, a Digital Versatile Disc ROM (DVD-ROM) drive 108, a Network Interface Card (NIC) 109, a sound processor 110, a monitor 111, and an Real Time Clock (RTC) 112.

The CPU 101 controls the operation of the whole information processing device 100, and is connected to each structural element thereof to exchange control signals and data therewith. The CPU 101 includes a register (unillustrated) which is a fast-accessible memory area. The CPU 101 can perform various operations on the resister using an Arithmetic Logic Unit (ALU) (unillustrated). Examples of such operations to be performed are arithmetic operations like addition, subtraction, multiplication, and division, logical operations like logical addition, logical multiplication, and logical negation, and bit operations like bitwise OR, bitwise AND, bit inversion, bit shifting, and bit rotation. The CPU 101 may itself be configured to perform high-speed saturate calculations like addition, subtraction, multiplication and division, and vector operations including trigonometric functions in order to cope with multimedia processing. Alternatively, the CPU 101 may include a coprocessor in order to realize these high-speed calculations. When a DVD-ROM is loaded in the DVD-ROM drive 108 and the information processing device 100 is powered on, the game device of the embodiment is realized.

An Initial Program Loader (IPL) which is executed immediately after the power is turned on is recorded in the ROM 102. Upon running of the IPL, the program recorded in the DVD-ROM is read in the RAM 103, and the CPU 101 starts running of such a program. An operating system program and various data that are necessary for controlling the operation of the whole information processing device 100 are recorded in the ROM 102.

The RAM 103 stores data and programs. The RAM 103 retains the program and data read from the DVD-ROM and other data necessary for advancing a game and chat communications. The CPU 101 has a variable area provided in the RAM 103. The CPU 101 may perform a calculation by causing the ALU directly to operate on a value stored in the variable area. The CPU 101 may once store a value stored in the RAM 103 in the register, and may perform a calculation on the register to write back calculation results in the memory.

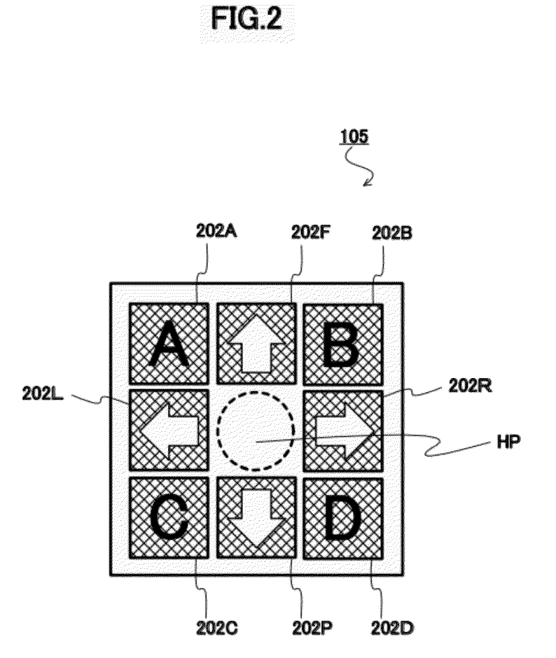

The mat-type controller 105 is connected to the information processing device 100 via the interface 104. The mat-type controller 105 receives an operation input given by a player for playing a game. FIG. 2 is an explanatory diagram showing an external appearance of the mat-type controller 105. An explanation will now be given of the mat-type controller 105 with reference to this drawing.

FIG. 2 is a schematic view of the mat-type controller 105 when the mat-type controller 105 is viewed from directly above disposed on a floor. Laid out at predetermined areas of the mat-type controller 105 are a button 202L that receives an input of a “left” instruction from the player, a button 202P that receives an input of a “rear” instruction from the player, a button 202F that receives an input of a “front” instruction from the player, and a button 202R that receives an input of a “right” instruction from the player, respectively. Moreover, a position indicated by a dashed circle in FIG. 2 is a home position HP of the player. Buttons 202A, 202B, 202C, and 202D are laid out at the front-left, the front-right, the rear-left, and the rear-right, respectively, relative to the home position HP. The player is allowed to depress respective buttons 202L, 202P, 202F, 202R, 202A, 202B, 202C, and 202D (hereinafter, collectively referred to as “buttons 202” as needed) at arbitrary timings. In the present embodiment, the buttons 202A, 202B, 202C, and 202D (hereinafter, collectively referred to as “oblique-direction buttons 202I” as needed) located in the oblique directions to the home position HP are not buttons that the player should step on. That is, the positions of the oblique-direction buttons 202I are positions that the player should not operate.

In the following explanation, a condition in which the button 202 is depressed by the player is referred to as a “depressed condition”, and a condition in which such a button is not depressed is referred to as a “non-depressed condition”. The CPU 101 determines for each button 202 whether it is in a depressed condition or in a non-depressed condition.

In the present embodiment, the mat-type controller 105 includes eight buttons, but the number of buttons is not limited to eight, and may be equal to or smaller than seven or equal to or larger than nine. Moreover, the configuration of the mat-type controller 105 is not limited to one disposed on the floor, but may be the other held by hands.

The external memory 106 is detachably connected to the information processing device 100 via the interface 104. The external memory 106 stores, in a rewritable manner, data representing a play state of the game or the like (past scores, etc.), data representing the progress state of the game, data on logs (records) for chat communications for a network match-up game. Upon inputting of an instruction by the player through the controller 105, those pieces of data can be recorded in the external memory 106 as needed.

The image processor 107 first allows the CPU 101 or an imaging engine (unillustrated) built in the image processor 107 to process data read from the DVD-ROM. Next, the image processor 107 records the processed data in a frame memory (unillustrated) of the image processor 107. Image information recorded in the frame memory is converted into video signals at predetermined synchronization timings and output to the monitor 111 connected to the image processor 107. This enables various types of image display.

A DVD-ROM to be loaded in the DVD-ROM drive 108 records a program for realizing the game and image data and sound data that accompany the game. Under the control of the CPU 101, the DVD-ROM drive 108 performs a read-out process on the loaded DVD-ROM to read the necessary program and data. The read program and data are temporarily stored in the RAM 103, etc.

The imaging engine can perform a high-speed overlay calculation of two-dimensional images, a transparency calculation like a blending, and various saturation calculations.

When a virtual space is formed in a three-dimensional space, it is also possible to perform a high-speed calculation of obtaining a rendered image having polygons disposed in the virtual space as viewed panoramically toward a predetermined direction of visual lines from a predetermined view position by rendering polygon information added with various pieces of texture information and disposed in the three-dimensional space through Z-buffering.

Furthermore, the CPU 101 and the imaging engine can operate in cooperation with each other to depict a string of letters as a two-dimensional image in the frame memory or on the surface of each polygon in accordance with font information. The font information defines the shape of a letter.

The NIC 109 is used for connecting the information processing device 100 to a computer communication network (unillustrated) like the Internet. The NIC 109 includes a 10BASE-T/100BASE-T standard compatible device used for establishing a Local Area Network (LAN), an analog modem, an Integrated Services Digital Network (ISDN) modem, or an Asymmetric Digital Subscriber Line (ADSL) modem for establishing a connection to the Internet via a telephone line, a cable modem for establishing a connection to the Internet via a cable television line, etc., and an interface (unillustrated) intervening between such a device and the CPU 101.

The sound processor 110 converts sound data read from the DVD-ROM into an analog sound signal, and outputs such analog sound signal from a speaker (unillustrated) connected thereto. Under the control of the CPU 101, the sound processor 110 generates a sound effect and music data to be generated in the progress of the game, and outputs a sound corresponding to the generated sound effect and music data from the speaker.

When the sound data recorded in the DVD-ROM is MIDI data, the sound processor 110 converts the MIDI data into PCM data by referring to sound source data included in the MIDI data. When the sound data is compressed sound data in the form of ADPCM, Ogg Vorbis, etc., the sound processor 110 extracts those pieces of data and converts those pieces of data into PCM data. The PCM data is subjected to Digital/Analog (D/A) conversion at a timing in accordance with a sampling frequency, and is output to the speaker. This enables sound output.

The monitor 111 is connected to the image processor 107, and displays image information upon a cooperative operation of the CPU 101 with the imaging engine. The monitor 111 is a Liquid Crystal Display (LCD), an organic electro-luminescence display or the like, which is in the form of a typical standing display or an HMD that is an attaching type.

The RTC 112 is a device that counts a time and includes a crystal oscillator or an oscillating circuit. The RTC 112 has a built-in battery that supplies power to the RTC 112, and keeps operating even if the information processing device 100 is powered off.

In addition, the information processing device 100 may include a large-capacity external memory device like a hard disk that realizes the same function from that of the ROM 102, the RAM 103, the external memory 106, or the DVD-ROM loaded in the DVD-ROM drive 108, and the like.

The information processing device 100 explained above is equivalent to a so-called “game device for consumers”, but the present invention can be realized by a device that performs an image processing for displaying a virtual space. Accordingly, the present invention can be realized on various computing machines, such as a cellular phone, a portable game device, a KARAOKE device, and a typical business computer.

For example, like the above-explained information processing device 100, typical computers include a CPU, a RAM, a ROM, a DVD-ROM drive, an NIC, and an image processor with a simplified function in comparison with that of the image processing device 100, and has a hard disk as an external memory device. Such a computer is also capable of using a flexible disk, a magneto-optical disk, a magnet tape, etc. Moreover, such a computer uses an input device that includes a keyboard and a mouse, not the mat-type controller 105.

<Explanation for Display Screen>

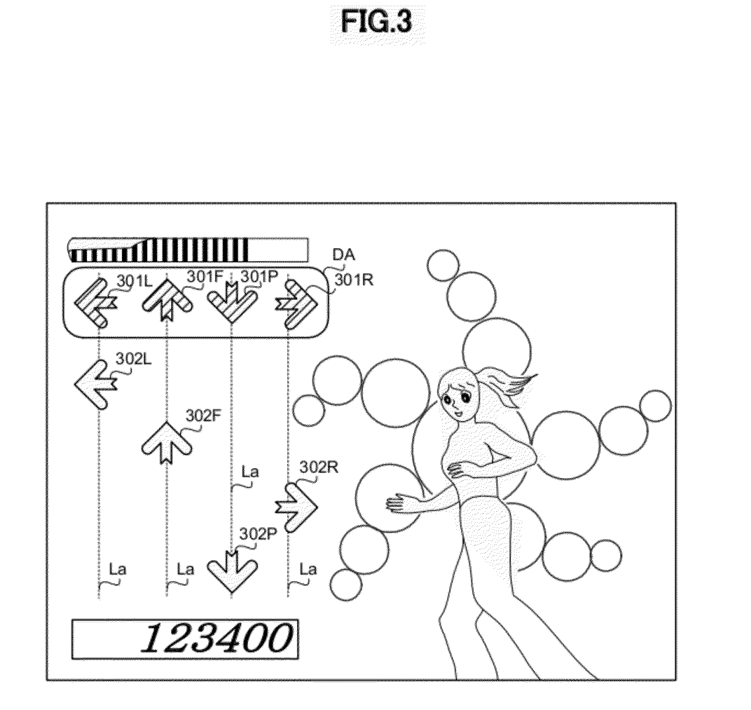

Next, an explanation will be given of a display screen of the game device according to the present embodiment with reference to FIG. 3. It is presumed that the game device of the present embodiment is a game device that executes a dancing game.

The game device displays various pieces of information necessary for the dancing game. For example, the game device displays a list of music, etc., before starting the game, and prompts a player to select desired music. The game starts when music is selected.

FIG. 3 is an illustrative display screen of the game device according to the present embodiment. Still markings 301L, 301P, 301F, and 301R (hereinafter, collectively referred to as still markings 301 as needed) in a game screen are fixed images indicating respective timings of stepping operations to the player. Stepping-position instructing markings 302L, 302P, 302F, and 302R (hereinafter, collectively referred to as stepping-position instructing markings 302 as needed) are displayed on moving lanes La in a scrolled manner from the bottom of the screen to the upper part thereof. When the stepping-position instructing marking 302 reaches a determination area DA and the player performs a requested stepping operation at a timing overlapping the still marking 301, a score is added. The kinds of the still markings 301 are back and forth and right and left only, and the player is not instructed to depress an oblique-direction button 202I.

According to the game screen shown in FIG. 3, the stepping-position instructing marking 302 moves from the bottom of the screen to the upper part thereof. However, the moving direction of the stepping-position instructing marking 302 is not limited to such a direction and is arbitrary. For example, the stepping-position instructing marking 302 may move from the upper part of the screen to the bottom thereof. Moreover, the stepping-position instructing marking 302 may move in the horizontal direction (from the right to the left or from the left to the right in the screen). Instead of the determination area DA, a determination line orthogonal to the moving lane La may be displayed and such a line may be used as the determination area. Furthermore, it is fine if the moving lane La is not displayed in the game screen.

The shape of the stepping-position instructing marking 302 is an example, and such a marking may be in other shape.

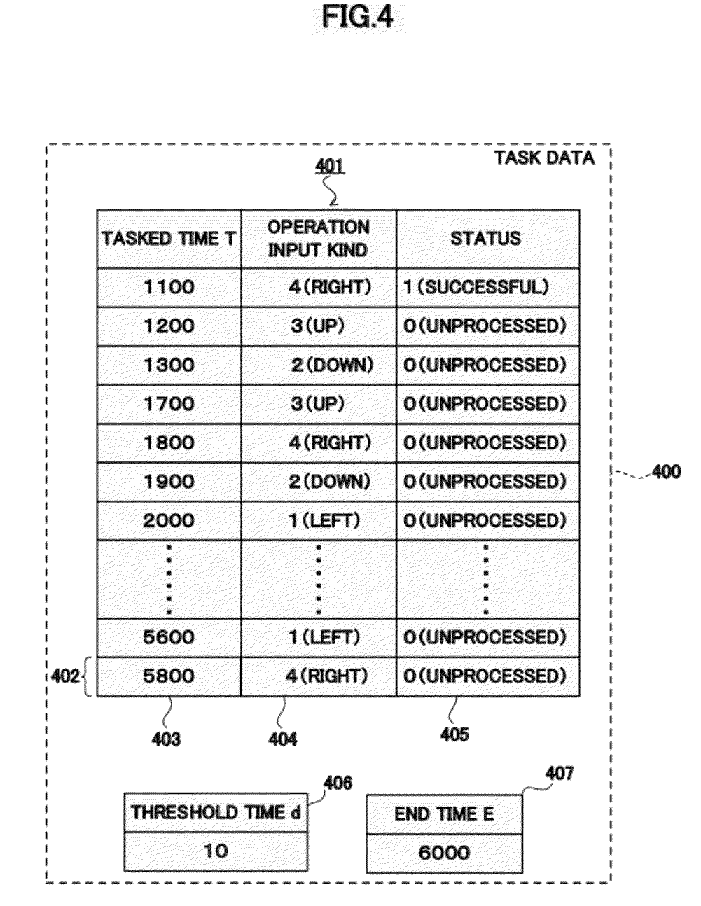

In the present embodiment, a music data string and task data are prepared in order to realize a game control process. The task data includes a plurality of tasked times, a kind of operation input associated with each of the plurality of tasked times, and a threshold time. FIG. 4 is an exemplary diagram of the task data.

Task data 400 corresponds to a musical score in the field of music. According to the present embodiment, the task data 400 includes a table 401 with a plurality of records 402, a threshold time 406 (the value thereof is defined as d), and an end time 407 (the value thereof is defined as E). Each record 402 includes regions for recording a tasked time 403 (the value thereof is defined as T), an operation input kind 404, and a status 405. Each record 402 corresponds to a music note.

The tasked time 403 is a time until the corresponding stepping-position instructing marking 302 reaches the still marking 301 from the beginning of the game. In the present embodiment, the tasked time 403 is represented by an integer value per a vertical synchronous interruption cycle. The tasked time 403 is information read from the DVD-ROM.

The operation input kind 404 is data indicating which button among the buttons 202L, 202P, 202F, and 202R of the mat-type controller 105 the player should step on when the corresponding tasked time has elapsed after the beginning of the game. The operation input kind 404 is information read from the DVD-ROM. In the field of the operation input kind 404, the kind of the button that should be operated is recorded as a number from “1” to “4”. For example, the buttons 202L, 202P, 202F, and 202R are indicated by numbers 1, 2, 3, and 4, respectively. The values indicating the kinds of the buttons are not limited to such numbers, and arbitrary number may be associated therewith.

The status 405 indicates a status of an operation input in each record 402. The status 405 is initialized right after the beginning of the game to “0” that indicates an “unprocessed” status, and is changed to “1” indicating a “success” or “2” indicating a “miss”, etc. The values indicating the status are not limited to such numbers, and an arbitrary number may be associated therewith.

The threshold time 406 represents an allowable value of a difference between the operation input given by the player and the tasked time 403. When a time difference between the timing at which the requested operation input is given and the tasked time 403 is equal to or less than the threshold time 406 and the operation input kind 404 matches the kind of the button 202 depressed, the operation input is taken as a successful operation.

The threshold time 406 is represented by an integer value per a vertical synchronous interruption cycle.

The end time 407 indicates a time until the play of the music ends after the beginning of the game. The end time 407 is represented by an integer value per a vertical synchronous interruption cycle.

<Configuration of Game Device>

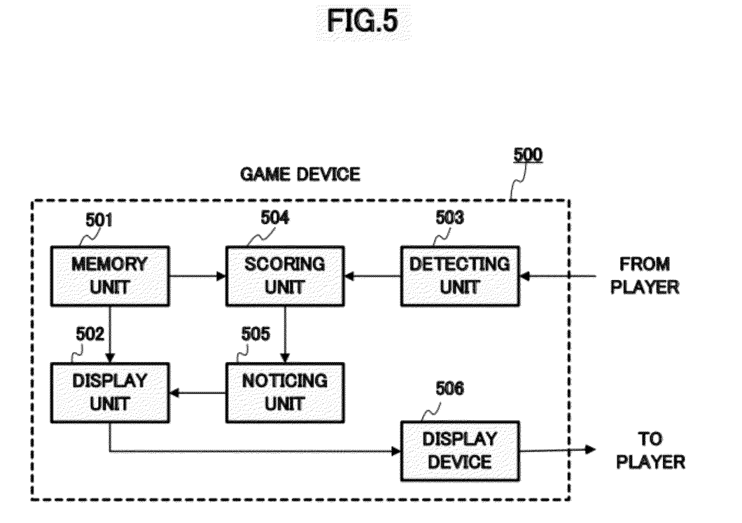

Next, the configuration of each unit of the game device will be explained with reference to FIG. 5.

A game device 500 of the present embodiment includes a memory unit 501, a display unit 502, a detecting unit 503, a scoring unit 504, a noticing unit 505, and a display device 506.

The memory unit 501 stores a plurality of tasked times 403 at which the player should give an operation, and operation input kinds 404 corresponding to the tasked times 403. The memory unit 501 also stores, for example, a background image displayed in the screen while the player is playing the game, and images of the stepping-position instructing markings 302 that move in synchronization with the rhythm, etc., of the played music.

The memory unit 501 is realized by the RAM 103, the external memory 106, and the DVD-ROM, etc.

The display unit 502 outputs a signal causing the display device 506 to display the corresponding stepping-position instructing marking 302 from a time preceding by a first time from the tasked time 403 and to a time having elapsed from the tasked time 403 by a second time. Moreover, the display unit 502 displays the background image and various messages, etc., in the screen.

The first time is set based on the distance from the bottom of the screen to the still marking 301 and the scrolling speed of the stepping-position instructing marking 302. Moreover, the second time is set based on the distance to the upper end of the determination area DA from the still marking 301 and the scrolling speed of the stepping-position instructing marking 302.

According to the present invention, it is appropriate if the display device 506 displays the corresponding stepping-position instructing marking 302 in the screen at least in the tasked time 403.

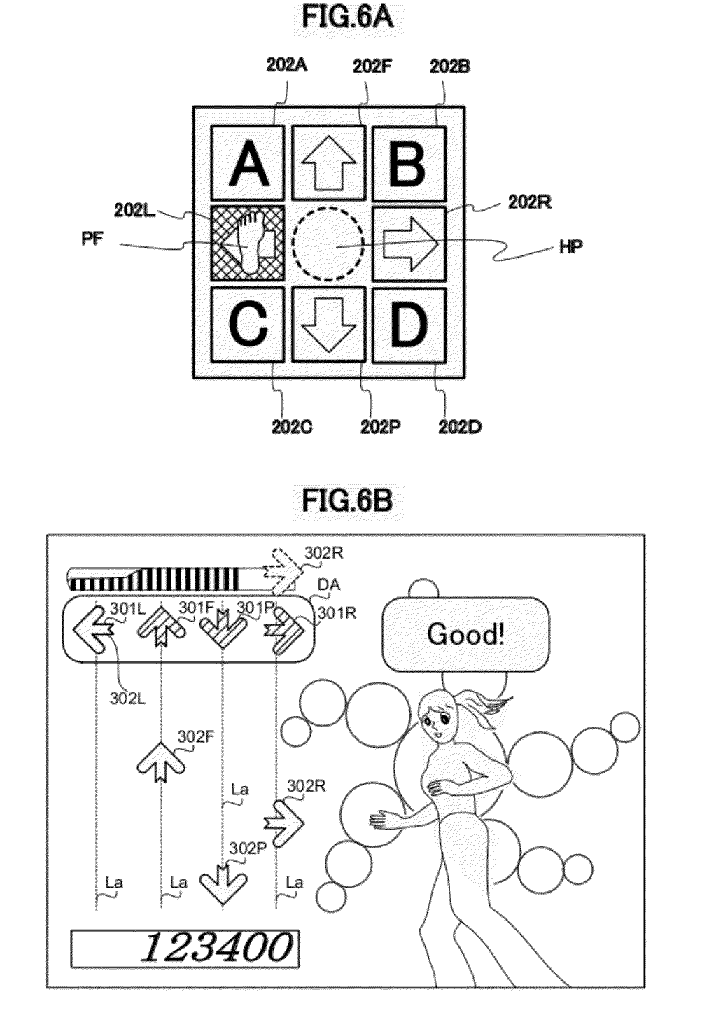

An explanation will be given of a screen display when the button 202 matching the operation input kind 404 is stepped on with reference to FIGS. 6A and 6B.

FIG. 6A shows an illustrative position where the player stepped on the button 202 of the mat-type controller 105. A foot PF indicates a position of the foot of the player when the player steps on the button. In the example case shown in FIG. 6A, the foot PF is located on the button 202L and the button 202L is stepped on.

Moreover, FIG. 6B shows an illustrative screen displayed when the player correctly steps on the button 202L at a timing at which the button 202L should be stepped on.

The display unit 502 displays a message “Good!” in the screen indicating that the player correctly stepped on the button 202L. The content of the message is not limited to this example, and is arbitrary.

The display unit 502 is realized by the CPU 101 and the image processor 107, etc.

The detecting unit 503 detects whether or not an operation is given by the player. When detecting that the player gives an operation, the detecting unit 503 detects the kind of the button 202 operated by the player on the mat-type controller 105.

The detecting unit 503 is realized by the mat-type controller 105, etc.

The scoring unit 504 obtains the score of the player based on whether or not the kind of the button 202 detected by the detecting unit 503 during a time period from a time preceding from the tasked time 403 by the threshold 406 to a time having elapsed from the tasked time 403 by the threshold time 406 matches the operation input kind 404. The detail of the process by the scoring unit 504 will be discussed later.

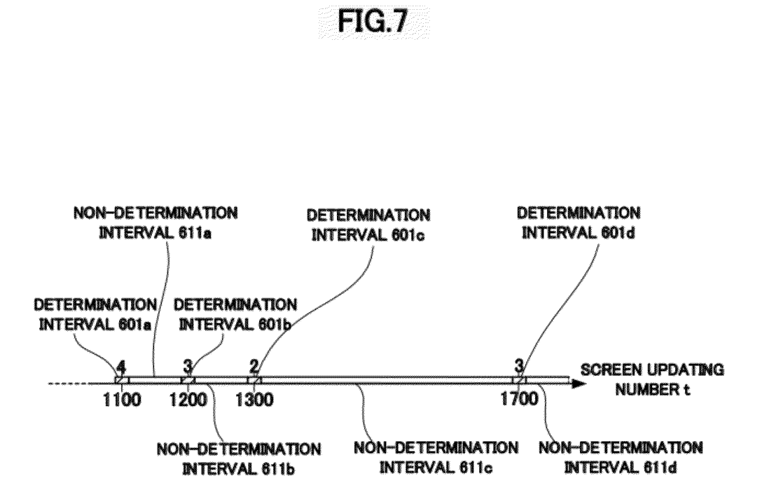

FIG. 7 shows a time range subjected to a score determination when the task data shown in FIG. 4 is used. Hereinafter, a time range having a time difference from the tasked time 403 being within the threshold time 406 is referred to as a “determination interval”, and a time range having the time difference from the tasked time 403 being larger than the threshold time 406 is referred to as a “non-determination interval”.

It is presumed that regarding the operation input kind 404 the buttons 202L, 202P, 202F, and 202R are indicated by values, 1, 2, 3, and 4, respectively.

For example, at a timing at which a screen updating number t reaches 1100, the operation input kind 404 requested is “4”. If the button 202R is depressed during a corresponding determination interval 601a, such an operation input is taken as a successful operation. Moreover, at a timing at which the screen updating number t reaches 1200, the operation input kind 404 requested is “3”. If the button 202F is depressed during a corresponding determination interval 601b, the operation input is taken as a successful operation.

Thereafter, the time range up to the determination interval 601b after a determination interval 601a is a non-determination interval 611a.

Likewise, the time range up to a determination interval 601c after the determination interval 601b is a non-determination interval 611b.

Subsequently, the time range held between the determination intervals 601 is likewise a non-determination interval 611.

The scoring unit 504 determines whether an operation input is successful or missed only when the operation input is given in the determination interval 601.

Returning now to FIG. 6B, the stepping-position instructing marking 302 corresponding to the record 402 that reaches the non-determination interval 611 beyond the determination interval 601 is not displayed under a normal condition. However, according to the present invention, the stepping-position instructing marking 302 reaching the non-determination interval 611 is indicated by dashed lines. In the example case shown in FIG. 6B, the “right” button 202R was supposed to be stepped on, and the stepping-position instructing marking 302R is drawn by dashed lines on the upper part of the determination area DA.

The scoring unit 504 is realized by the CPU 101 and the RTC 112, etc.

The noticing unit 505 gives a notice to the player when the detecting unit 503 detects an operation given by the player and the kind of the button 202 stepped on by the player is any one of the oblique-direction buttons 202I. In the first present embodiment, a timing at which the player gives an operation is not taken into consideration by the noticing unit 505.

More specifically, the noticing unit 505

(i) presents a notice when a position that should not be operated is depressed,

(j) does not present a notice when the button 202 which is different from the operation input kind 404 indicated in the record 402 but which is a candidate button 202 to be operated is depressed, and

(k) does not present a notice when no button 202 is depressed.

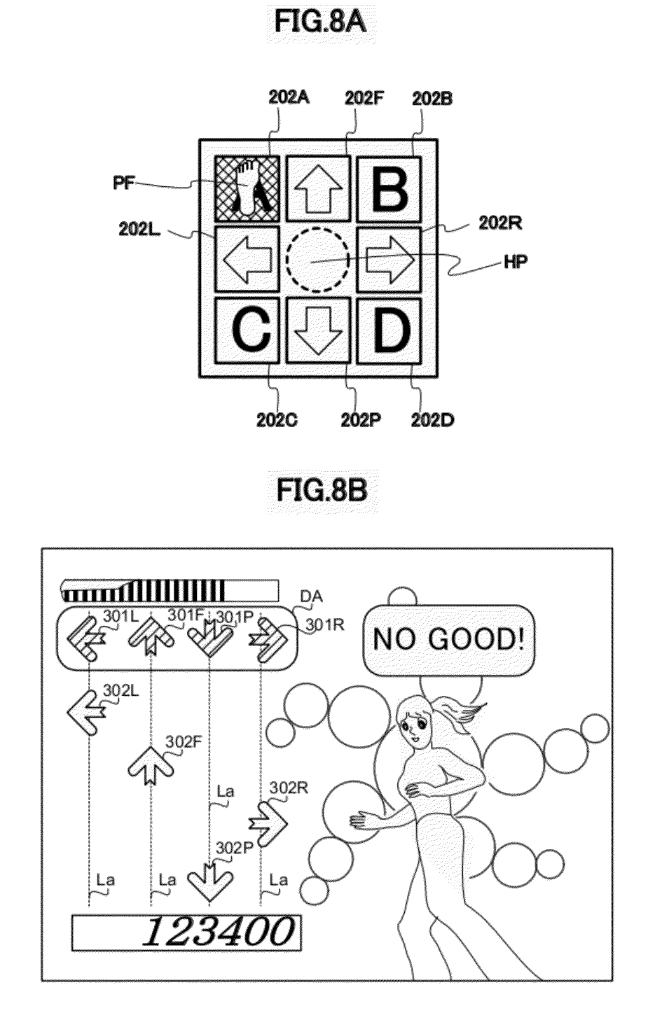

An explanation will be given of a screen display when any one of the oblique-direction buttons 202I is stepped on mistakenly with reference to FIGS. 8A and 8B.

FIG. 8A shows an illustrative position at which the player steps on the oblique-direction button 202I on the mat-type controller 105. In the illustrative case shown in FIG. 8A, the button 202A is stepped on.

Moreover, FIG. 8B shows an illustrative screen displayed when the player mistakenly steps on the button 202A.

The noticing unit 505 displays in the screen a message “No Good” indicating that the button 202A is mistakenly stepped on. According to the present embodiment, it is presumed that the number of kinds of the message to be displayed is one. The content of the message is not limited to the above-explained example, and is arbitrary.

The way how the noticing unit 505 presents a notice is not limited to a screen display, and is arbitrary. For example, the noticing unit 505 may present a notice by outputting a sound.

The noticing unit 505 is realized by the CPU 101, etc.

The display device 506 displays an image including a notice message and the like in accordance with a signal supplied from the display unit 502.

The display device 506 is realized by the monitor 111.

<Operation of Game Device>

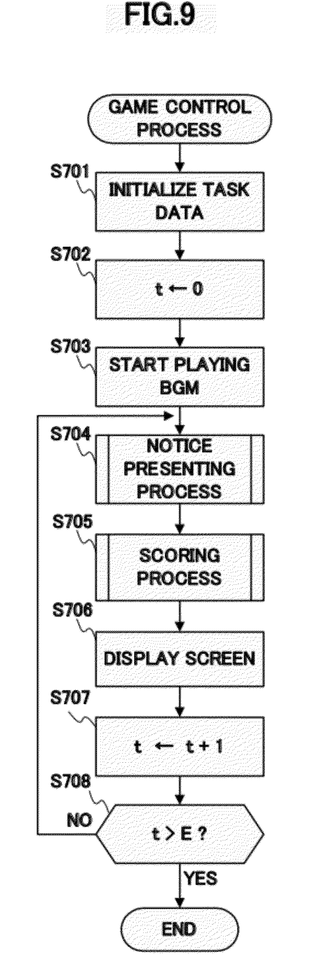

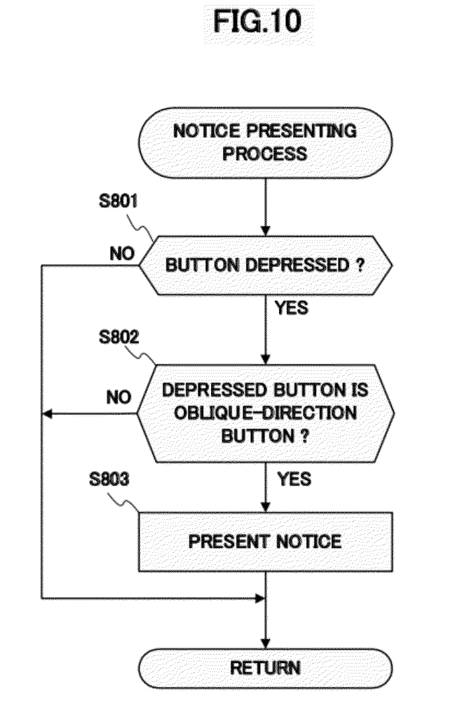

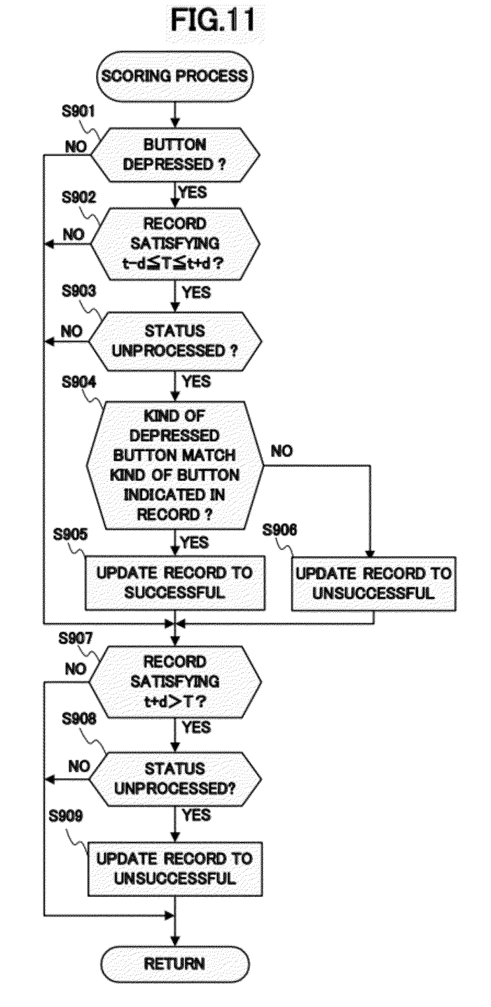

Next, an explanation will be given of an operation of the game device 500 according to the present embodiment with reference to FIGS. 9 to 11. FIG. 9 is a flowchart showing a game control process executed by the game device 500 of the present embodiment. Moreover, FIG. 10 is a flowchart showing a notice presenting process executed by the game device 500 of the present embodiment. Furthermore, FIG. 11 is a flowchart showing a scoring process executed by the game device 500 of the present embodiment.

When a button (hereinafter, a correct button) that should be depressed among the buttons 202 is depressed within the range of the difference that is the threshold d from the tasked time 403, the game device 500 determines that an operation input is successful. Conversely, when a button that should not be depressed among the buttons 202 is depressed within the range of the difference that is the threshold d from the tasked time 403, or when no button among the buttons 202 is depressed within the range of the difference that is the threshold d from the tasked time 403, the game device 500 determines that an operation input is unsuccessful. When the oblique-direction button 202I is depressed, the game device 500 presents a notice.

First, the CPU 101 reads the task data 400 from the DVD-ROM and extracts the read data in a predetermined task-data area of the RAM 103, and initializes such data (step S701).

Next, the CPU 101 initializes the present screen updating number (the value thereof is defined as t) to 0 (step S702).

Next, the CPU 101 causes the sound processor 110 to start playing a BGM associated with the task data 400 (step S703). The sound data string of the BGM is recorded in the DVD-ROM in the form of Pulse Code Modulation (PCM), MPEG Layer 3 (MP3), Ogg Vorbis, or Musical Instrument Digital Interface (MIDI), etc.

Next, the CPU 101 shifts the process to the notice presenting process (step S704). The notice presenting process is for presenting a notice to the player when the oblique-direction button 202I is depressed.

The detail of the notice presenting process will be discussed later. As will be explained in other embodiments, the notice presenting process has various versions.

Next, the CPU 101 executes the scoring process (step S705). The detail of the scoring process will be explained later. The scoring process is for obtaining a score based on a success/failure of an operation input given by the player.

The execution order of the notice presenting process and the scoring process may be inverse. Moreover, the notice presenting process and the scoring process have the common steps as will be discussed later. Therefore, the notice presenting process and the scoring process may be combined as a single process.

Following the scoring process (step S705), the CPU 101 displays a screen together with the image processor 107 (step S706). The screen shown in FIG. 3 is displayed through this process.

As explained above, the stepping-position instructing marking 302 is displayed in a scrolled manner from the bottom of the screen to the upper part thereof on the moving lane La. Next, the player is required to step on the corresponding button 202 at a timing at which the still marking 301 on the upper part of the screen completely overlaps the stepping-position instructing marking 302.

Next, the CPU 101 increments the screen updating number t (step S707). Thereafter, the CPU 101 determines whether or not the screen updating number t exceeds the end time E (step S708). When the screen updating number t does not exceed the end time E (step S708: NO), the CPU 101 repeats the process from the step S704 to the step S707. That is, when the CPU 101 determines that the screen updating number t does not exceed the end time E, the process returns to the step S704.

Conversely, when the screen updating number t exceeds the end time E (step S708: YES), the game device 500 terminates the game process.

An explanation will be given of the detail of the notice presenting process with reference to the flowchart of FIG. 10.

The CPU 101 checks whether or not any one of the buttons 202 of the mat-type controller 105 is depressed (step S801). When any one of the buttons 202 is depressed (step S801: YES), the CPU 101 progresses the process to the process in step S802.

In the step S802, the CPU 101 determines whether or not the depressed button 202 is the oblique-direction button 202I. When the depressed button 202 is the oblique-direction button 202I (step S802: YES), the CPU 101 presents a notice message on the screen in cooperation with the image processor 107 (step S803). In the present embodiment, the number of the kinds of the notice message is one.

Conversely, when no button 202 is depressed (step S801: NO) or when the depressed button 202 is not the oblique-direction button 202I (step S802: NO), the CPU 101 terminates the notice presenting process.

Next, an explanation will be given of the detail of the scoring process with reference to the flowchart of FIG. 11.

First, the CPU 101 checks whether or not any one of the buttons 202 of the mat-type controller 105 is depressed (step S901). When any one of the buttons 202 is depressed (step S901: YES), the CPU 101 progresses the process to step S902. Conversely, when no button 202 is depressed (step S901: NO), the CPU 101 progresses the process to step S907.

The CPU 101 determines in the step S902 whether or not there is the record 402 that satisfies a condition t−d≦T≦t+d. That is, the CPU 101 determines whether or not the present time is the above-explained determination interval 601. When determining that there is the record 402 that satisfies a condition t−d≦T≦t+d (step S902: YES), the CPU 101 progresses the process to step S903. Conversely, when determining that there is no record 402 that satisfies a condition t−d≦T≦t+d (step S902: NO), the CPU 101 progresses the process to step S907.

The CPU 101 determines in the step S903 whether or not the status 405 of the record 402 that satisfies a condition t−d≦T≦t+d is “unprocessed”. That is, the CPU 101 determines whether or not success/fail of the record 402 is already determined. When the status 405 of the record 402 is “unprocessed” (step S903: YES), the CPU 101 progresses the process to step S904. Conversely, when determining that the status 405 of the record 402 is not “unprocessed” (step S903: NO), the CPU 101 progresses the process to the step S907.

The CPU 101 determines in the step S904 whether or not the depressed button 202 is the button 202 matching the operation input kind 404. When determining that the depressed button 202 matches the operation input kind 404 (step S904: YES), the CPU 101 updates the status 405 of the record 402 to “successful” (step S905). Conversely, when determining that the depressed button 202 does not match the operation input kind 404 (step S904: NO), the CPU 101 updates the status 405 of the record 402 to “unsuccessful” (step S906). After the step S905 or the step S906, the CPU 101 progresses the process to the step S907.

It is assumed that the operation input kind 404 indicated in the record 402 is “3”, i.e., the “front” button should be depressed. The CPU 101 executes any one of the following processes from (l) to (n).

(l) updating the status 405 of the record 402 to “unsuccessful” when a position that should not be operated, i.e., the oblique-direction button 202I is depressed,

(m) updating the status 405 of the record 402 to “unsuccessful” when the button 202 which is different from the operation input kind 404 indicated in the record 402, i.e., the “front” button 202F, and which becomes the button 202 to be operated in a future,

(n) updating the status 405 of the record 402 to “successful” when the “front” button 202F is depressed.

Unlike the notice presenting process, when the button 202 which is different from the operation input kind 404 indicated in the record 402 but which becomes the button 202 to be operated in a future is depressed, the CPU 101 updates the status 405 of the record 402 to “unsuccessful”.

The CPU 101 determines in the step S907 whether or not there is the record 402 that satisfies a condition t+d>T. That is, the CPU 101 determines whether or not there is the record 402 having the tasked time 403 smaller than a time having elapsed by the threshold d from the present screen updating number t. In other words, the CPU 101 determines whether or not there is the record 402 that has passed the time range subjected to determination for scoring, i.e., the determination interval 601. When determining that there is the record 402 that satisfies a condition t+d>T (step S907: YES), the CPU 101 progresses the process to step S908. Conversely, when determining that there is no record 402 that satisfies a condition t+d>T (step S907: NO), the CPU 101 terminates the scoring process.

The CPU 101 determines in the step S908 whether or not the status 405 of the record 402 that satisfies a condition t+d>T is “unprocessed”. When determining that the status 405 of the record 402 is “unprocessed” (step S908: YES), the CPU 101 updates the status 405 of the record 402 to “unsuccessful” (step S909), and terminates the scoring process. Conversely, when determining that the status 405 of the record 402 is not “unprocessed” (step S908: NO), the CPU 101 terminates the scoring process.

According to the above-explained embodiment, when the player depresses a button that should not have been operated, a notice is presented, thereby prompting the player not to operate a position that should not be operated.

According to the first embodiment, when, for example, both “right” and “front-right” buttons are simultaneously operated at a timing at which the “right” button should be operated, a notice message is displayed and a screen indicates that an operation is successful and a score is obtained.

### Second Embodiment

According to the above-explained first embodiment, the number of kinds of the notice message is one. According to the present embodiment, however, a notice message in accordance with the kind of the depressed oblique-direction button 202I is presented.

A game device 500 according to the present embodiment is realized by the above-explained information processing device 100, and includes the same structural elements as those of the first embodiment. However, the game device 500 has the noticing unit 505 that has a different function from that of the noticing unit 505 of the first embodiment.

The noticing unit 505 of the present embodiment presents a notice corresponding to the kind of the depressed oblique-direction button 202I.

According to the first embodiment, the number of kinds of the message to be displayed is one. In contrast, according to the present embodiment, when the front-left button 202A and the front-right button 202B are depressed, a notice message “excessively forward!” is displayed. Moreover, when the rear-left button 202C and the rear-right button 202D are depressed, a notice message “excessively rearward!” is displayed.

More specifically, in the present embodiment, when the player steps on the buttons 202A and 202B located at the front of the mat-type controller 105, since the position that should not have been operated is stepped on, the notice message “excessively forward” relative to the home position HP is displayed. Moreover, when the player steps on the buttons 202C and 202D located at the rear of the mat-type controller 105, since the position that should not have been operated is stepped on, the notice message “excessively rearward!” relative to the home position HP is displayed. Two kinds of messages are displayed according to the present embodiment. The contents of the messages are not limited to the above examples as long as the message changes depending on the kind of the oblique-direction button 202I, and are arbitrary.

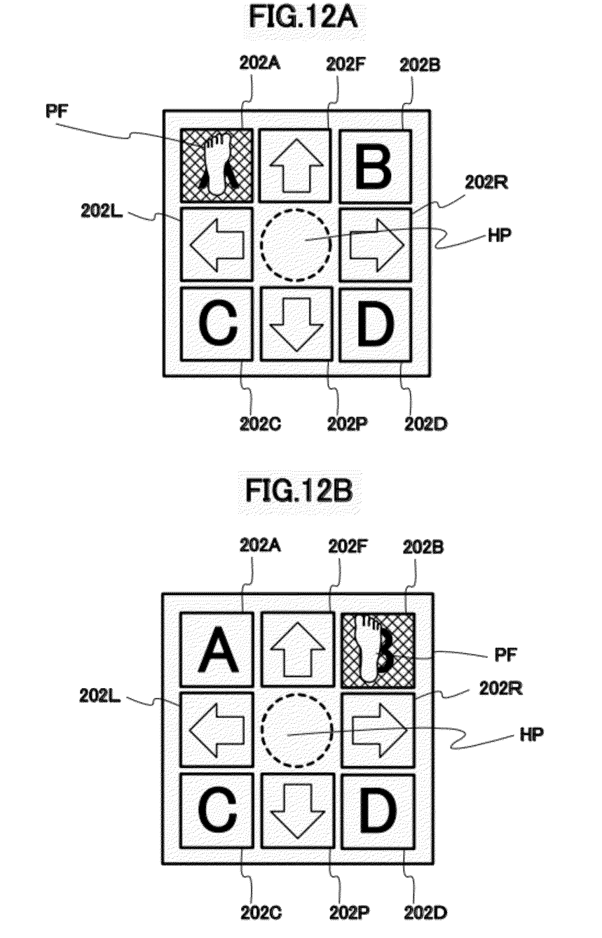

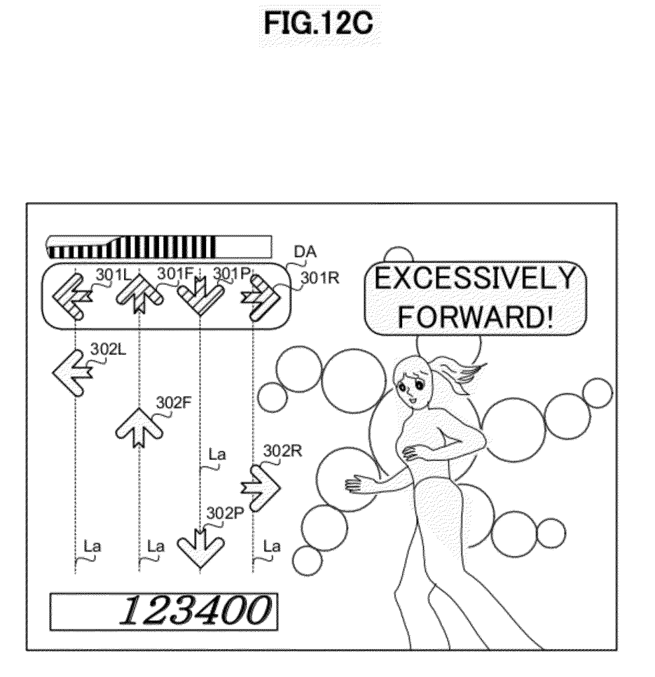

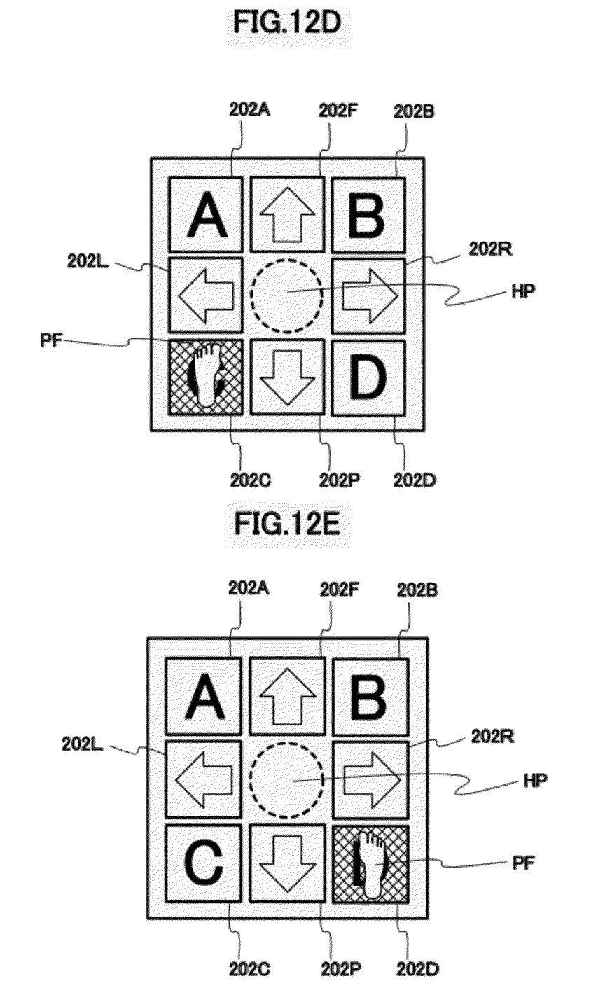

FIGS. 12A and 12B show illustrative positions where the player steps on the oblique-direction buttons 202I on the mat-type controller 105. In the case of FIG. 12A, the button 202A is stepped on by the foot PF, and in the case of FIG. 12B, the button 202B is stepped on by the foot PF.

Moreover, FIG. 12C shows an illustrative screen displayed when the player mistakenly steps on the button 202A or 202B.

The noticing unit 505 displays in the screen the message “excessively forward” indicating that the button 202A or 202B is mistakenly stepped on.

FIGS. 12D and 12E show illustrative positions where the player steps on the oblique-direction buttons 202I on the mat-type controller 105. In the case of FIG. 12D, the button 202C is stepped on by the foot PF, and in the case of FIG. 12E, the button 202D is stepped on by the foot PF.

FIG. 12F shows an illustrative screen displayed when the player mistakenly steps on the button 202C or 202D.

The noticing unit 505 displays in the screen the message “excessively rearward!” indicating that the button 202C or 202D is mistakenly stepped on.

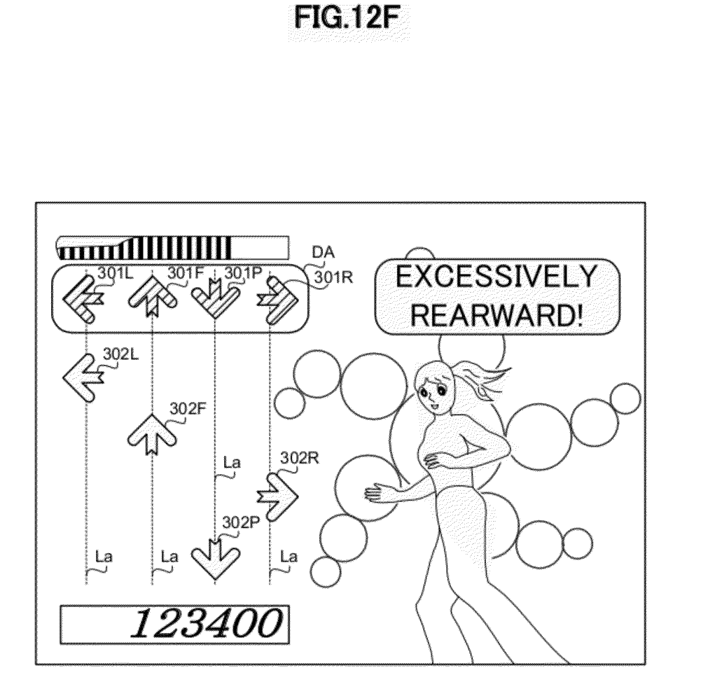

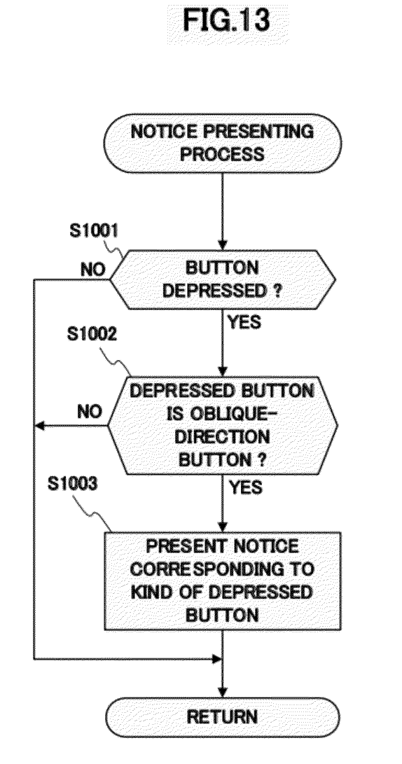

The game device 500 of the present embodiment executes the similar process as that of the flowchart of FIG. 9. However, the detail of the notice presenting process in the step S704 is different. FIG. 13 shows the detail of the notice presenting process according to the present embodiment.

First, the CPU 101 checks whether or not any one of the buttons 202 of the mat-type controller 105 is depressed (step S1001). When any one of the buttons 202 is depressed (step S1001: YES), the CPU 101 progresses the process to step S1002. Conversely, When no button 202 is depressed (step S1001: NO), the CPU 101 terminates the notice presenting process.

The CPU 101 determines in the step S1002 whether or not the depressed button 202 is the oblique-direction button 202I. When the depressed button 202 is the oblique-direction button 202I (step S1002: YES), the CPU 101 presents a notice in accordance with the kind of the depressed oblique-direction button 202I (step S1003), and terminates the notice presenting process. Conversely, when the depressed button is not the oblique-direction button 202I (step S1002: NO), the CPU 101 terminates the notice presenting process.

According to the present embodiment, when the player depresses a button that should not have been operated, a notice depending on the kind of the depressed button is presented, thereby prompting the player to correct the improper stepping in the back-and-forth direction.

Likewise the first embodiment, in the second embodiment, when, for example, both “right” and “front-right” buttons are simultaneously operated at a timing at which the “right” button should be operated, the notice message is displayed and a screen indicates that an operation is successful and a score is obtained.

### Third Embodiment

According to the above-explained embodiments, a timing at which an operation input is given is out of consideration. According to the present embodiment, however, only when the oblique-direction button 202I is depressed in the above-explained non-determination interval 611, a notice is presented. In the determination interval 601, a message relating to the score like “Good!” is possibly displayed in the screen. If the message relating to the score and a notice message are simultaneously displayed, the visibility of the screen decreases. Hence, according to the present embodiment, a notice message is displayed only in the non-determination interval 611 in order to prevent the visibility of the screen from decreasing.

A game device 500 according to the present embodiment is realized by the above-explained information processing device 100, and includes the same structural elements as those of the above-explained embodiments. However, the game device 500 has the noticing unit 505 that has a different function from that of the noticing unit 505 of the above-explained embodiments.

The noticing unit 505 of the present embodiment presents a notice in accordance with the kind of the depressed oblique-direction button 202I only when the oblique-direction button 202I is depressed during the non-determination interval 611.

More specifically, when the player steps on the buttons 202A and 202B located at the front of the mat-type controller 105 in the non-determination interval 611, since the position that should not have been operated is stepped on, the notice message “excessively forward!” relative to the home position HP is displayed. Moreover, when the player steps on the buttons 202C and 202D located at the rear of the mat-type controller 105 in the non-determination interval 611, since the position that should not have been operated is stepped on, the notice message “excessively rearward!” relative to the home position HP is displayed. The contents of the messages are not limited to the above examples as long as the message changes depending on the kind of the oblique-direction button 202I, and are arbitrary.

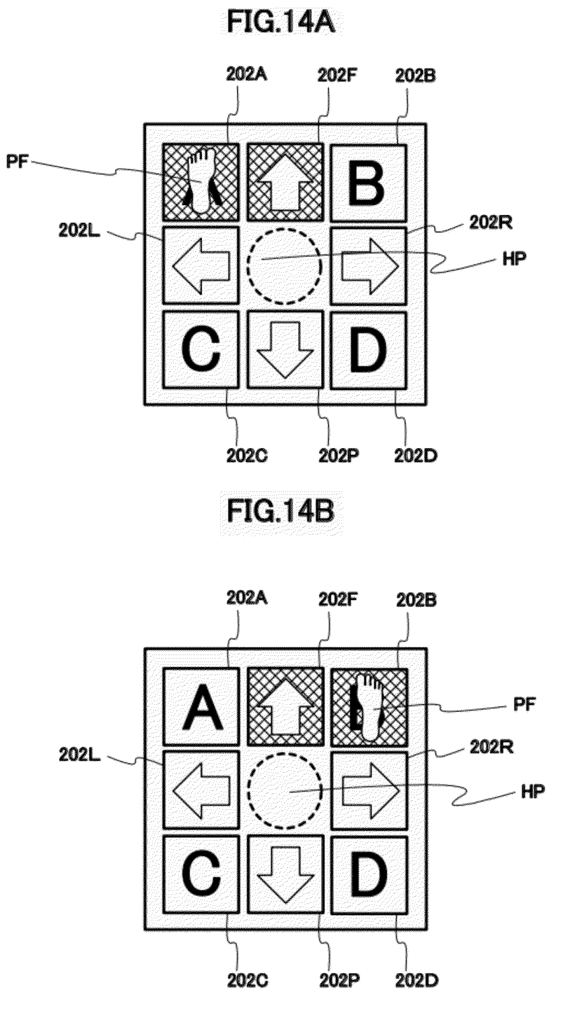

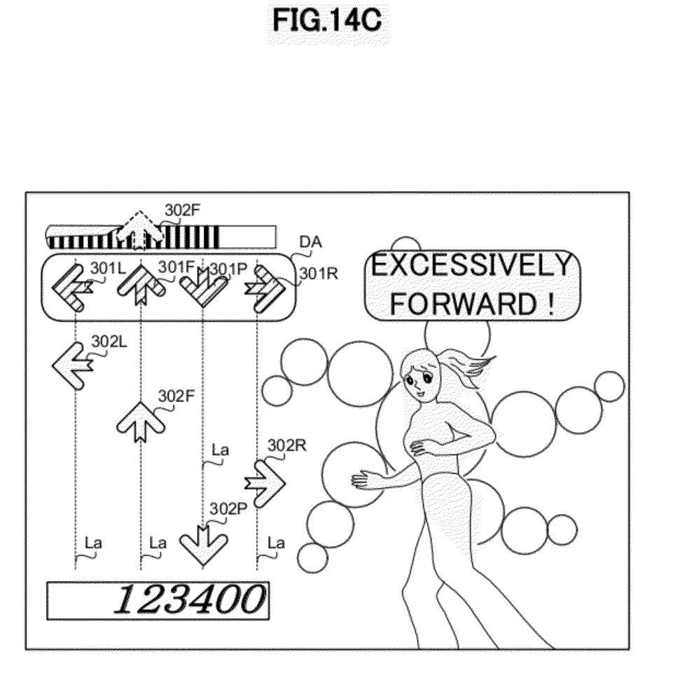

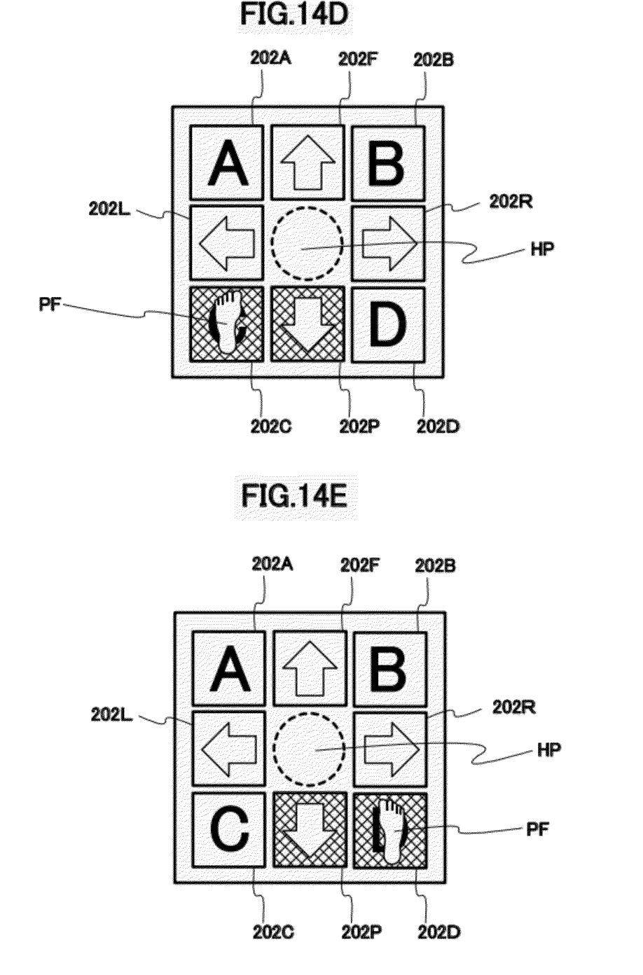

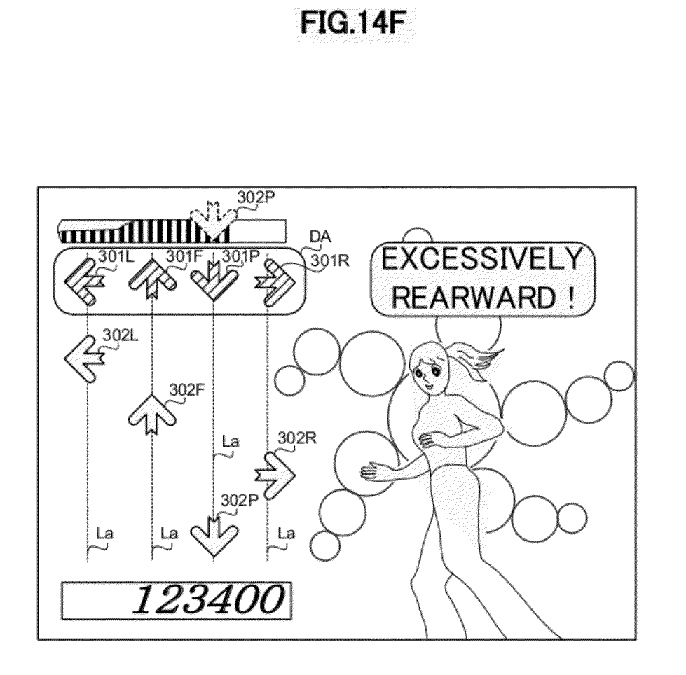

FIGS. 14A and 14B show illustrative positions where the player steps on the buttons of the mat-type controller 105 that should not have been stepped on when the player should step on the “front” button 202F relative to the center home position HP. In the case of FIG. 14A, the button 202A is stepped on by the foot PF, and in the case of FIG. 14B, the button 202B is stepped on by the foot PF.

FIG. 14C shows an illustrative screen displayed when the player mistakenly steps on the button 202A or 202B in a case in which the player should step on the “front” button 202F relative to the center home position HP.

The noticing unit 505 displays in the screen the message “excessively forward!” indicating that the button 202A or 202B is mistakenly stepped on.

FIGS. 14D and 14E show illustrative positions where the player steps on the buttons on the mat-type controller 105 that should not have been stepped on when the player should step on the “rear” button 202P relative to the center home position HP. In the case of FIG. 14D, the button 202C is stepped on by the foot PF and in the case of FIG. 14E, the button 202D is stepped on by the foot PF.

FIG. 14F shows an illustrative screen displayed when the player mistakenly steps on the button 202C or 202D in a case in which the “rear” button 202P should be stepped on relative to the center home position HP.

The noticing unit 505 displays on a screen a message “excessively rearward!” indicating that the button 202C or 202D is mistakenly stepped on.

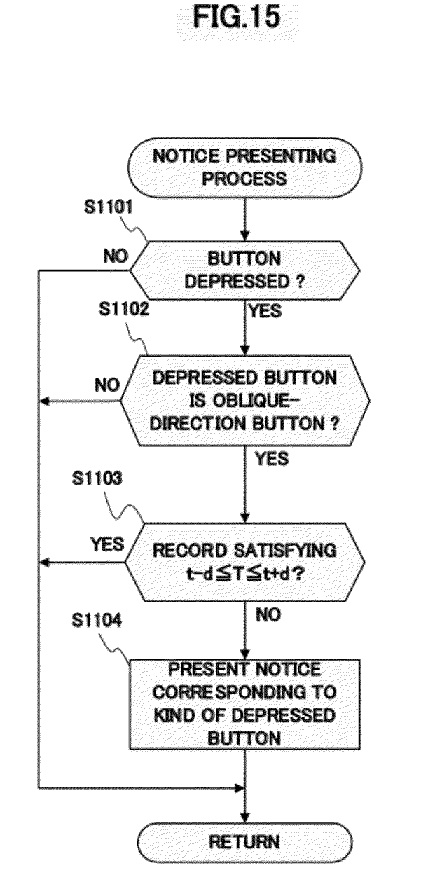

The game device 500 of the present embodiment executes the similar process as that of the flowchart of FIG. 9. However, the detail of the notice presenting process in the step S704 is different. FIG. 15 shows the detail of the notice presenting process according to the present embodiment.

First, the CPU 101 checks whether or not any one of the buttons 202 of the mat-type controller 105 is depressed (step S1101). When any one of the buttons 202 is depressed (step S1101: YES), the CPU 101 progresses the process to step S1102. Conversely, When no button 202 is depressed (step S1101: NO), the CPU 101 terminates the notice presenting process.

The CPU 101 determines in the step S1102 whether or not the depressed button 202 is the oblique-direction button 202I. When the depressed button 202 is the oblique-direction button 202I (step S1102: YES), the CPU 101 progresses the process to step S1103. Conversely, when the depressed button 202 is not the oblique-direction button 202I (step S1102: No), the CPU 101 terminates the notice presenting process.

The CPU 101 determines in the step S1103 whether or not there is the record 402 that satisfies a condition t−d≦T≦t+d. That is, the CPU 101 determines whether or not the present screen updating number t is within the determination interval 601. When determining that there is the record 402 that satisfies a condition t−d≦T≦t+d (step S1103: YES), the CPU 101 terminates the notice presenting process. Conversely, when determining that there is no record 402 that satisfies a condition t−d≦T≦t+d (step S1103: NO), the CPU 101 presents a notice in accordance with the kind of the depressed oblique button 202I (step S1104), and terminates the notice presenting process.

According to the third embodiment, unlike the first and second embodiments, when, for example, both “right” and “front-right” buttons are simultaneously operated at a timing at which the “right” button should be operated, a screen indicates that an operation is successful and a score is obtained, but a notice is not displayed. Hence, according to the present embodiment, it becomes possible to prompt the player to depress a correct position without decreasing the visibility of the screen.

### Fourth Embodiment

According to the above-explained third embodiment, when the oblique-direction button 202I is depressed in the non-determination interval 611 shown in FIG. 7, a notice message in accordance with the kind of the depressed oblique-direction button 202I is presented. According to the present embodiment, however, a notice message corresponding to a relative positional relationship between the depressed oblique-direction button 202I and the button 202 that should be depressed in the most recent task information is presented. The detail of the present embodiment will now be explained.

A game device 500 according to the present embodiment is realized by the above-explained information processing device 100, and includes the same structural elements as those of the above-explained embodiments. However, the game device 500 of the present embodiment has the noticing unit 505 that has a different function from that of the noticing unit 505 of the above-explained embodiments.

The noticing unit 505 of the present embodiment presents a notice message only when the oblique-direction button 202I is depressed in the above-explained non-determination interval 611. The content of the notice message to be presented is associated with the relative positional relationship between the depressed oblique-direction button 202I and the button 202 which should be depressed and indicated by the operation input kind 404 in the most recent task information.

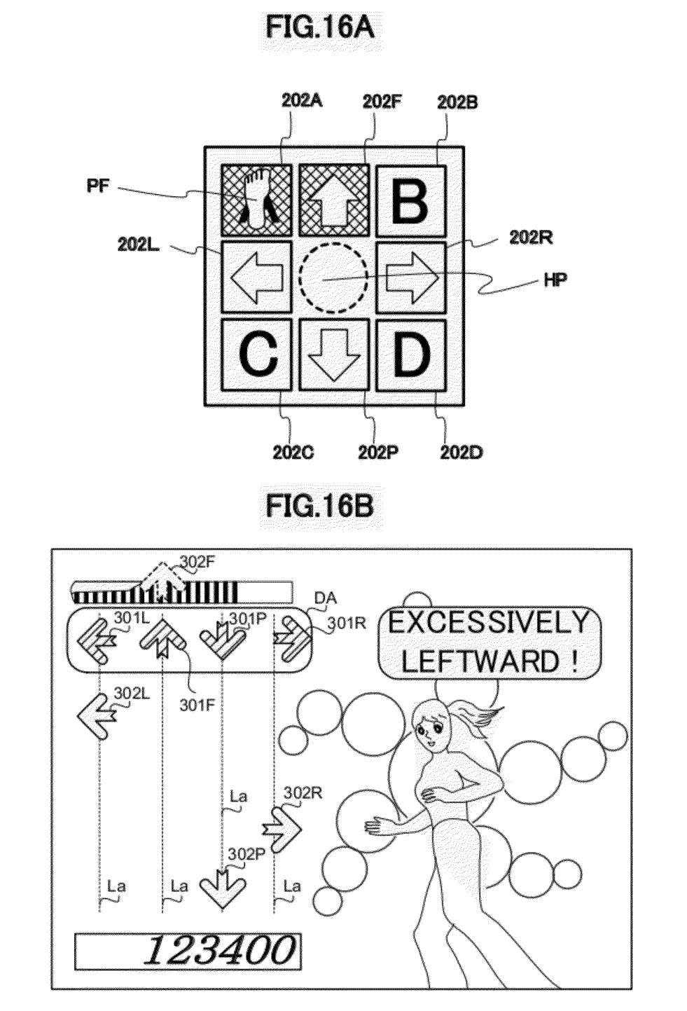

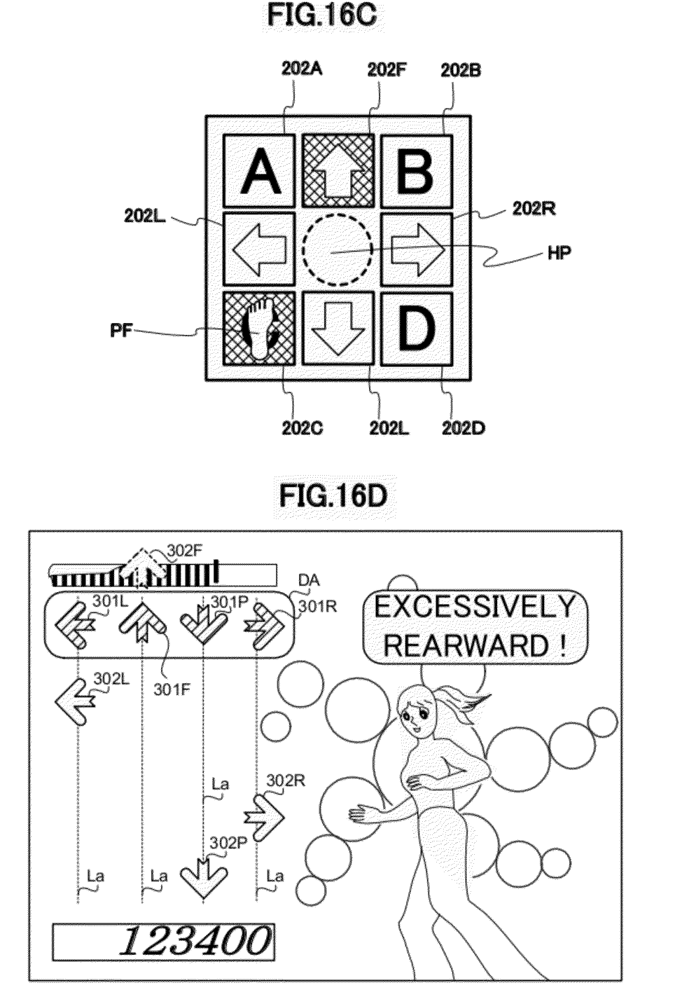

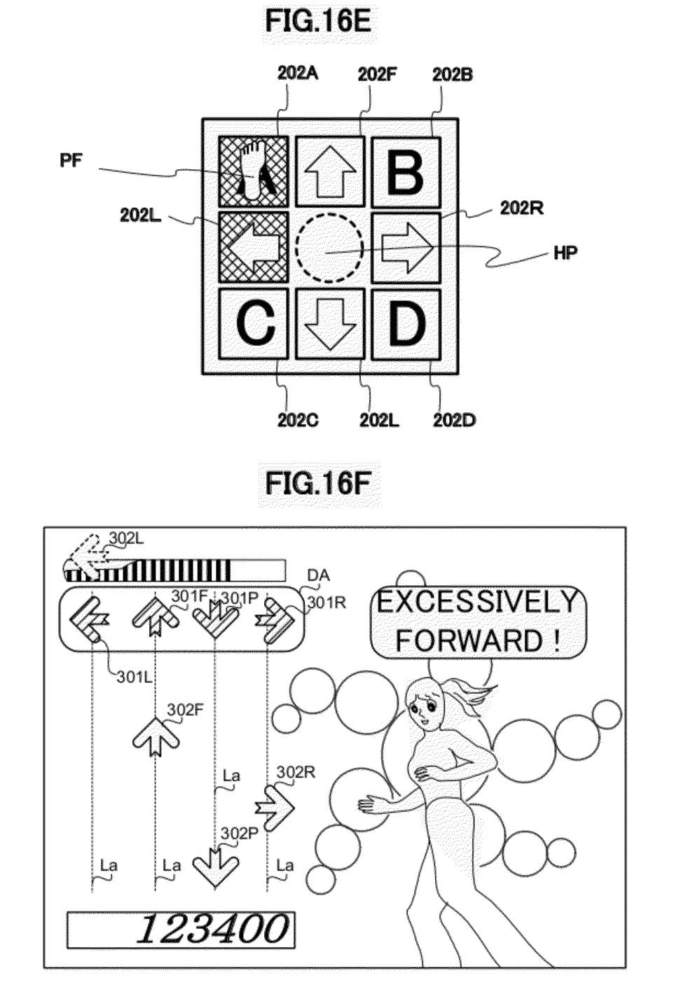

FIGS. 16A to 16F show a specific example. FIGS. 16A and 16C show illustrative positions where the player steps on the buttons on the mat-type controller 105 that should not have been stepped on when the “front” button 202F relative to the center home position HP should be depressed in the most recent task, and FIGS. 16B and 16D show illustrative screens displayed at that time. In the case of FIG. 16A, the player steps on the button 202A when the “front” button 202F should be depressed.

The button 202A is located at the left of the “front” button 202F. Hence, as shown in FIG. 16B, the noticing unit 505 presents a notice message “excessively leftward!”.

Moreover, in the case of FIG. 16C, the player steps on the button 202C when the “front” button 202F should be depressed. The button 202C is located at the rear of the “front” button 202F. Hence, as shown in FIG. 16D, the noticing unit 505 presents a notice message “excessively rearward!”.

FIG. 16E shows an illustrative position where the player steps on the button on the mat-type controller 105 that should not have been be stepped on when the “left” button 202L relative to the center home position HP should be depressed in the most recent task. In the case of FIG. 16E, the button 202A is stepped on when the “left” button 202L should be depressed. Moreover, FIG. 16F shows an illustrative screen displayed at this time.

The button 202A is located at the front of the “left” button 202L. Hence, as shown in FIG. 16F, the noticing unit 505 presents a notice message “excessively forward!”.

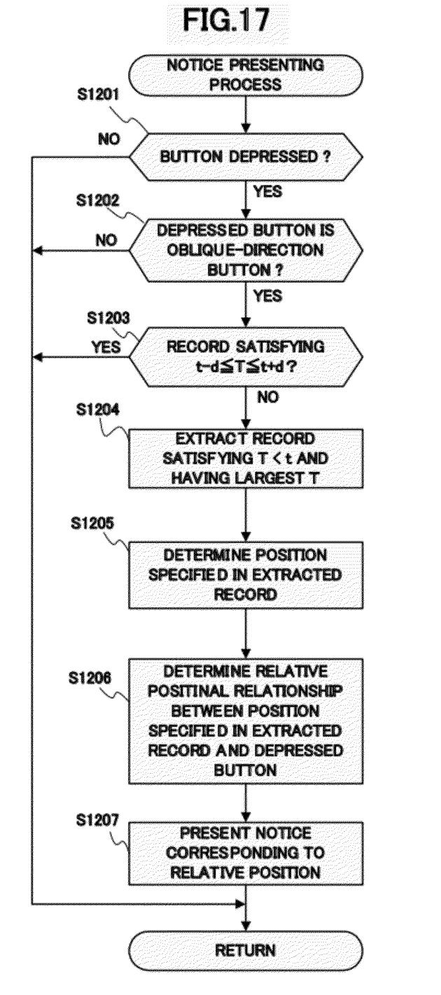

The game device 500 of the present embodiment executes the similar process as that of the flowchart of FIG. 9. However, the detail of the notice presenting process in the step S704 is different. FIG. 17 shows the detail of the notice presenting process according to the present embodiment.

First, the CPU 101 checks whether or not any one of the buttons 202 of the mat-type controller 105 is depressed (step S1201). When any one of the buttons 202 is depressed (step S1201: YES), the CPU 101 progresses the process to step S1202. Conversely, When no button 202 is depressed (step S1201: NO), the CPU 101 terminates the notice presenting process.

The CPU 101 determines in the step S1202 whether or not the depressed button 202 is the oblique-direction button 202I. When the depressed button 202 is the oblique-direction button 202I (step S1202: YES), the CPU 101 progresses the process to step S1203. Conversely, when the depressed button 202 is not the oblique-direction button 202I (step S1202: No), the CPU 101 terminates the notice presenting process.

The CPU 101 determines in the step S1203 whether or not there is the record 402 that satisfies a condition t−d≦T≦t+d. That is, the CPU 101 determines whether or not the present screen updating number t is within the determination interval 601. When determining that there is the record 402 that satisfies a condition t−d≦T≦t+d (step S1203: YES), the CPU 101 terminates the notice presenting process. Conversely, when determining that there is no record 402 that satisfies a condition t−d≦T≦t+d (step S1203: NO), the CPU 101 extracts the record 402 which satisfies a condition T<t and which has the largest T (step S1204). That is, the CPU 101 extracts the most recent record 402 having a timing of an operation input which is indicated by the tasked time T and which has already passed.

Next, the CPU 101 detects the kind of the button 202 to be depressed which is indicated by the operation input kind 404 in the extracted record 402 (step S1205).

The CPU 101 determines the relative positional relationship between the kind of the button 202 to be depressed specified in the extracted record 402 and the depressed oblique-direction button 202I (step S1206). When, for example the player depresses the button 202B at a timing at which the player should depress the button 202P located at the “rear” of the home position HP, the CPU 101 determines that the right side of the button 202P that should be depressed is depressed.

Next, the CPU 101 presents a notice message corresponding to the determined relative position (step S1207), and terminates the notice presenting process. When, for example, the player depresses the button 202B at a timing at which the player should depress the button 202P located at the “rear” of the home position HP, the CPU 101 presents a notice message “excessively rightward!” in the screen.

According to the present embodiment, a notice in accordance with the kind of the depressed button is presented when the player depresses the button that should not have been be operated, thereby prompting the player to correct the stepping of the improper position.

### Fifth Embodiment

According to the above-explained fourth embodiment, a notice message corresponding to the relative positional relationship between the depressed oblique-direction button 202I and the button 202 that should be depressed in the most recent task information is presented. According to the present embodiment, however, when the button 202 that should be depressed in the most recent task information and the depressed oblique-direction button 202I adjoin to each other, a notice message corresponding to the relative positional relationship therebetween is presented. Conversely, when the button 202 that should be depressed in the most recent task information and the depressed oblique-direction button 202I do not adjoin to each other, a notice message in accordance with the kind of the oblique-direction button 202I is presented.

A game device 500 according to the present embodiment is realized by the above-explained information processing device 100, and includes the same structural elements as those of the above-explained embodiments. However, the game device 500 of the present embodiment has the noticing unit 505 that has a different function from that of the noticing unit 505 of the above-explained embodiments.

The noticing unit 505 of the present embodiment presents a notice message when the oblique-direction button 202I is depressed in the above-explained non-determination interval 611.

When the button 202 that should be depressed in the most recent task information and the depressed oblique-direction button 202I adjoin to each other, the noticing unit 505 presents a notice message corresponding to the relative positional relationship therebetween. Moreover, when the button 202 that should be depressed in the most recent task information and the depressed oblique-direction button 202I do not adjoin to each other, the noticing unit 505 presents a notice message in accordance with the kind of the depressed oblique-direction button 202I.

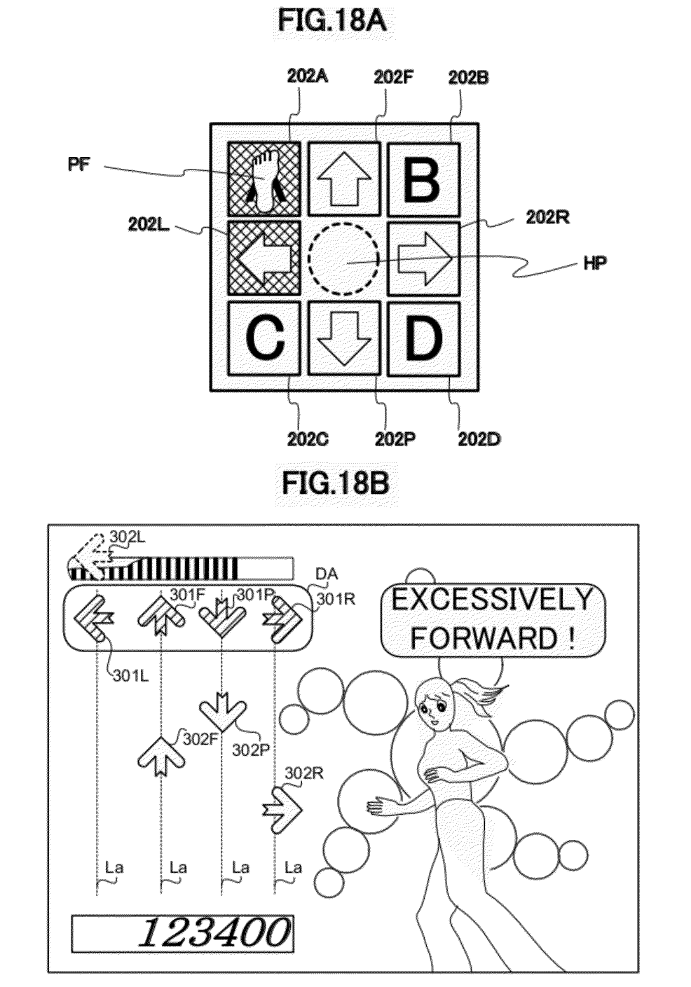

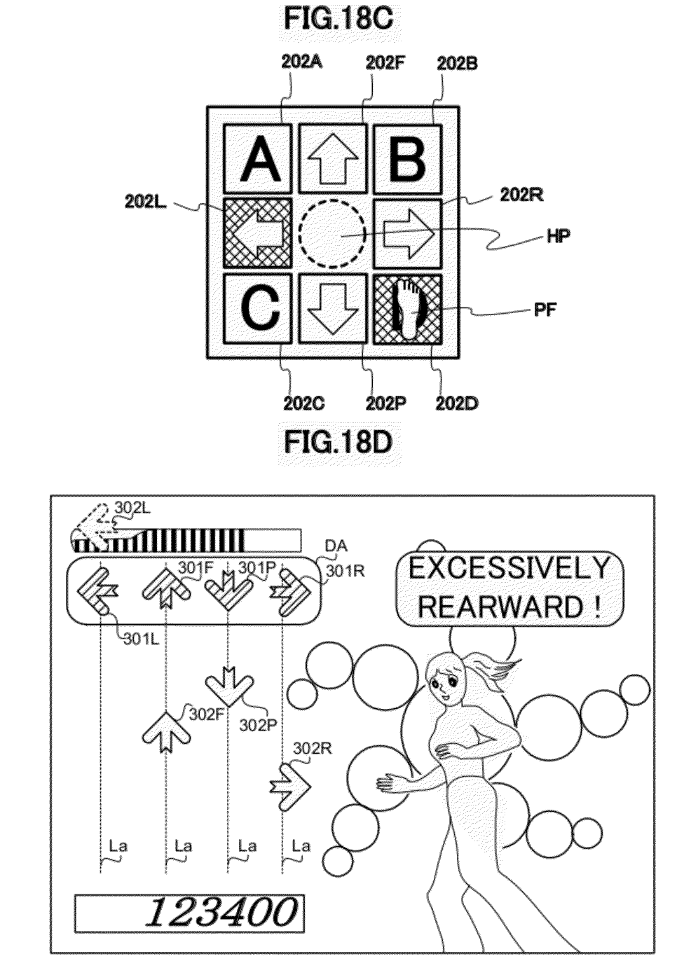

FIGS. 18A to 18D show a specific example. FIGS. 18A and 18C show illustrative positions where the player steps on the buttons on the mat-type controller 105 that should not have been be stepped on when the “left” button 202L relative to the center home position HP should be depressed in the most recent task. FIGS. 18B and 18D show illustrative screens displayed at this time. In the case of FIG. 18A, the player steps on the button 202A when the “left” button 202L should be depressed.

The button 202A adjoins to the “left” button 202L. Hence, as shown in FIG. 18B, the noticing unit 505 presents a notice message “excessively forward!” based on the positional relationship between the button 202A and the button 202L.

In the case of FIG. 18C, the player steps on the button 202D when the player should depress the “left” button 202L. The button 202D does not adjoin to the “left” button 202L. Hence, the noticing unit 505 does not present a notice message “excessively rightward!” that is based on the positional relationship between the button 202D and the button 202L. Instead, as shown in FIG. 18D, the noticing unit 505 presents a notice message “excessively rearward!” corresponding to the button 202D.

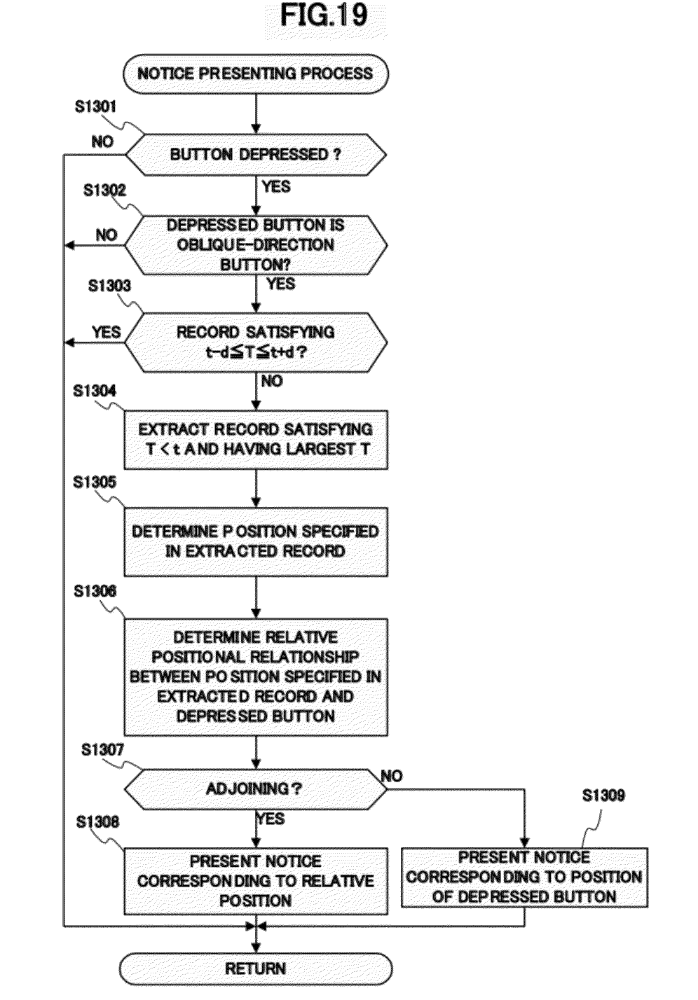

The game device 500 of the present embodiment executes the similar process as that of the flowchart of FIG. 9. However, the detail of the notice presenting process in the step S704 is different. FIG. 19 shows the detail of the notice presenting process according to the present embodiment.

First, the CPU 101 checks whether or not any one of the buttons 202 of the mat-type controller 105 is depressed (step S1301). When any one of the buttons 202 is depressed (step S1301: YES), the CPU 101 progresses the process to step S1302. Conversely, When no button 202 is depressed (step S1301: NO), the CPU 101 terminates the notice presenting process.

The CPU 101 determines in the step S1302 whether or not the depressed button 202 is the oblique-direction button 202I. When the depressed button 202 is the oblique-direction button 202I (step S1302: YES), the CPU 101 progresses the process to step S1303. Conversely, when the depressed button 202 is not the oblique-direction button 202I (step S1302: No), the CPU 101 terminates the notice presenting process.

The CPU 101 determines in the step S1303 whether or not there is the record 402 that satisfies a condition t−d≦T≦t+d. That is, the CPU 101 determines whether or not the present screen updating number t is within the determination interval 601. When determining that there is the record 402 that satisfies a condition t−d≦T≦t+d (step S1303: YES), the CPU 101 terminates the notice presenting process. Conversely, when determining that there is no record 402 that satisfies a condition t−d≦T≦t+d (step S1303: NO), the CPU 101 extracts the record 402 which satisfies a condition T<t and which has the largest T (step S1304). That is, the CPU 101 extracts the most recent record 402 having a timing of an operation input which is indicated by the tasked time T and which has already passed.

Next, the CPU 101 determines the position that should be depressed, i.e., the kind of the button 202 indicated by the operation input kind 404 in the extracted record 402 (step S1305).

The CPU 101 determines the relative positional relationship between the kind of the button 202 which should be depressed and which is specified in the extracted record 402 and the depressed oblique-direction button 202I (step S1306).

Next, the CPU 101 determines whether or not the button 202 which should be depressed and which is specified in the extracted record 402 and the depressed oblique-direction button 202I adjoin to each other (step S1307). When, for example, the player depresses the button 202B at a timing at which the player should depress the button 202P located at the “rear” of the home position HP, the CPU 101 determines that those buttons do not adjoin to each other. Moreover, when, for example, the player depresses the button 202D at a timing at which the player should depress the button 202P located at the “rear” of the home position HP, the CPU 101 determines that those buttons adjoin to each other.

When determining that those buttons adjoin to each other (step S1307: YES), the CPU 101 presents a notice corresponding to the relative positional relationship between the button 202 which should be depressed and which is specified in the extracted record 402 and the depressed oblique-direction button 202I (step S1308), and terminates the notice presenting process. When, for example, the player depresses the button 202D at a timing at which the player should depresses the button 202P located at the “rear” of the home position HP, the CPU 101 displays a notice message “excessively rightward!” in the screen.

Conversely, when determining that those buttons do not adjoin to each other (step S1307: NO), the CPU 101 presents a notice corresponding to the depressed position, i.e., the kind of the depressed oblique-direction button 202I (step S1309), and terminates the notice presenting process. When, for example, the player depresses the button 202B at a timing at which the player should depress the button 202P located at the “rear” of the home position HP, the CPU 101 displays a notice message “excessively forward!” in the screen, and terminates the notice presenting process.

According to the present embodiment, the content of the notice is changed depending on the distance between the position indicated by the most recent record and the position depressed by the player. This enables the player to adjust the position of an operation input more precisely.

### Sixth Embodiment

According to the above-explained embodiments, the number of buttons 202 that should be simultaneously depressed is one. According to the present embodiment, however, the plurality of buttons 202 may be subjected to a simultaneous depression.

A game device 500 according to the present embodiment is realized by the above-explained information processing device 100, and includes the same structural elements as those of the above-explained embodiments. However, the game device 500 of the present embodiment has the noticing unit 505 that has a different function from that of the noticing unit 505 of the above-explained embodiments.

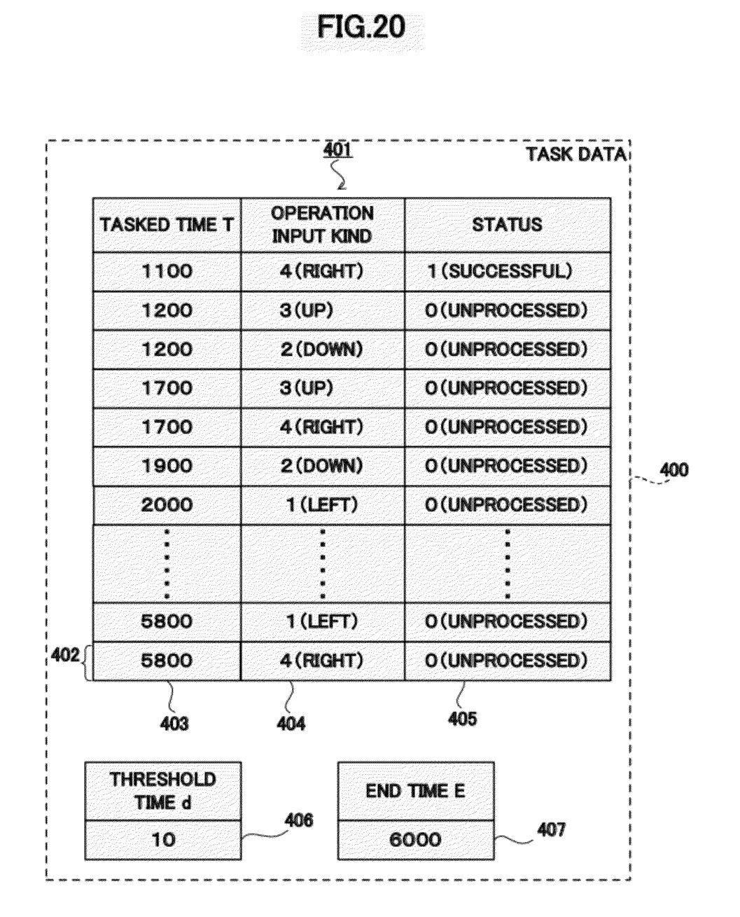

FIG. 20 shows illustrative task data according to the present embodiment.

According to the present embodiment, there are the plurality of records 402 indicating the same tasked time T in some cases. For example, there are two records 402 having the tasked time T that is 1200, two records 402 having the tasked time T that is 1700, and two records 402 having the tasked time T that is 5800. That is, the player is required to simultaneously depress the two buttons 202 that should be depressed at a time at which the screen updating number t is 1200, 1700 or 5800.

According to the present embodiment, when the number of buttons 202 adjoining the depressed oblique-direction button 202I among the plurality of buttons 202 that should be depressed is one, a notice message based on the positional relationship between the adjoining button 202 and the oblique-direction button 202I is presented.

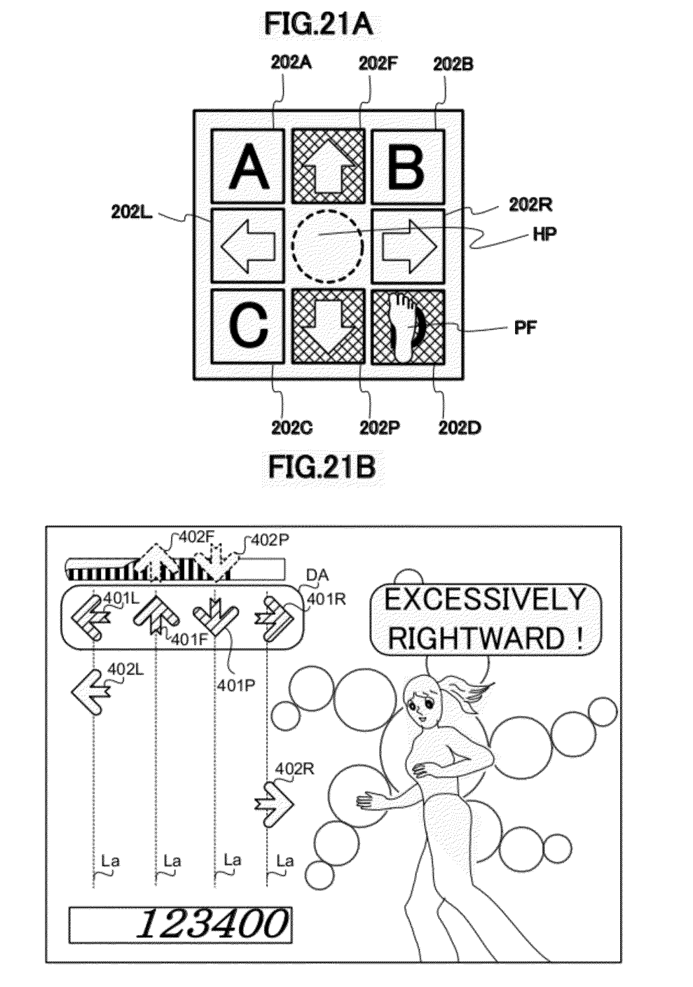

FIGS. 21A and 21B show a specific example. FIG. 21A shows an illustrative position where the player depresses the mat-type controller 105 when the player should depress the “front” and “rear” buttons 202F and 202P relative to the center home position HP in the most recent task. FIG. 21B shows an illustrative screen displayed at this time. In the case of FIG. 21A, the player steps on the button 202D when the player should depress the “front” and “rear” buttons 202F and 202P.

The button 202D does not adjoin to the “front” button 202F, but adjoins to the “rear” button 202P. Hence, as shown in FIG. 21B, the noticing unit 505 presents a notice message “excessively rightward!” corresponding to the positional relationship between the button 202P and the button 202D.

When the number of the depressed oblique-direction buttons 202I and the adjoining buttons 202 that should be depressed is a plural number, the noticing unit 505 executes any one of the following processes from (p) to (r).

(p) displaying a notice message at random corresponding to either one of the oblique-direction button and the button that should be depressed.

(q) setting a preference to either one of “back and forth” and “right and left” in advance, and displaying a corresponding notice message.

(r) displaying a notice message corresponding to the position of the depressed oblique-direction button 202I regardless of the adjoining positional relationship.

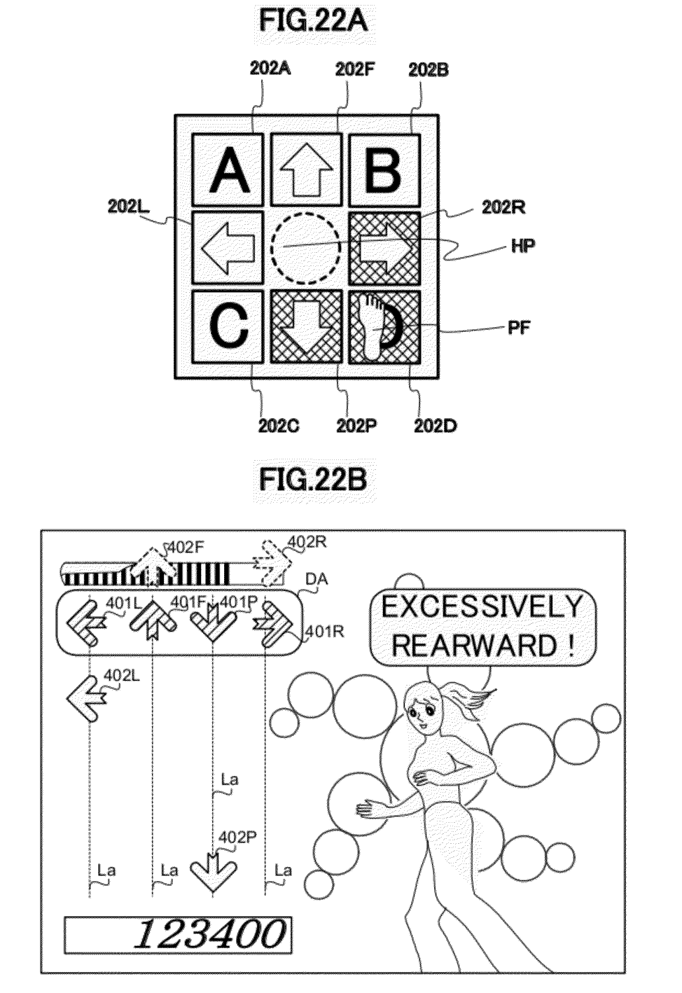

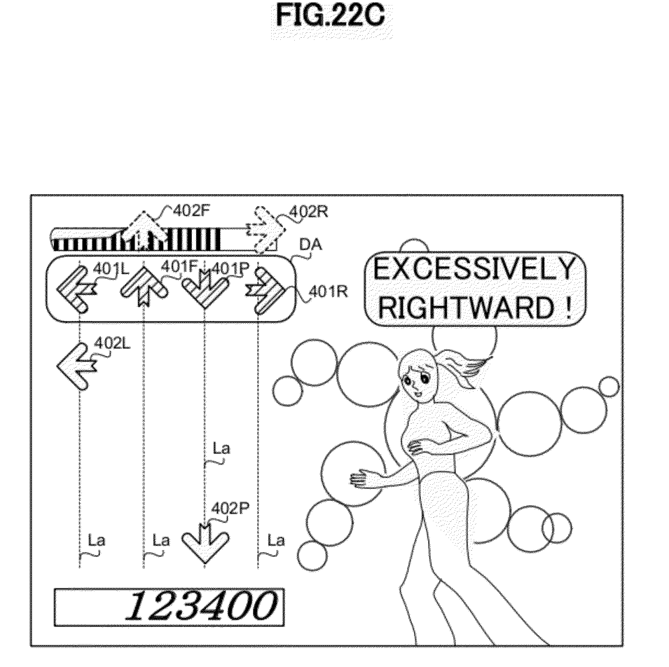

FIGS. 22A to 22C show a specific example. FIG. 22A shows an illustrative position on which the player steps when the “rear” and “right” buttons 202P and 202R relative to the center home position HP should be depressed in the most recent task. FIGS. 22B and 22C show illustrative screens displayed at this time. In the case of FIG. 22A, the player steps on the button 202D when the player should step on the “rear” and “right” buttons 202P and 202R.

The button 202D adjoins to the “rear” and “right” buttons 202P and 202R.

When the noticing unit 505 executes the process of (p), a notice message “excessively rearward!” shown in FIG. 22B and corresponding to the positional relationship between the button 202R and the button 202D or a notice message “excessively rightward!” shown in FIG. 22C and corresponding to the positional relationship between the button 202P and the button 202D is displayed at random.

When the noticing unit 505 executes the process of (q), a preference to either one of “back and forth” and “right and left” is set in advance. When a preference is given to “back and forth”, the noticing unit 505 presents a notice message “excessively rearward!” shown in FIG. 22B. Moreover, when a preference is given to “right and left”, the noticing unit 505 presents a notice message “excessively rightward!” shown in FIG. 22C.

When executing the process of (r), the noticing unit 505 presents a notice message “excessively rearward!”, as shown in FIG. 22B, and corresponding to the button 202D.

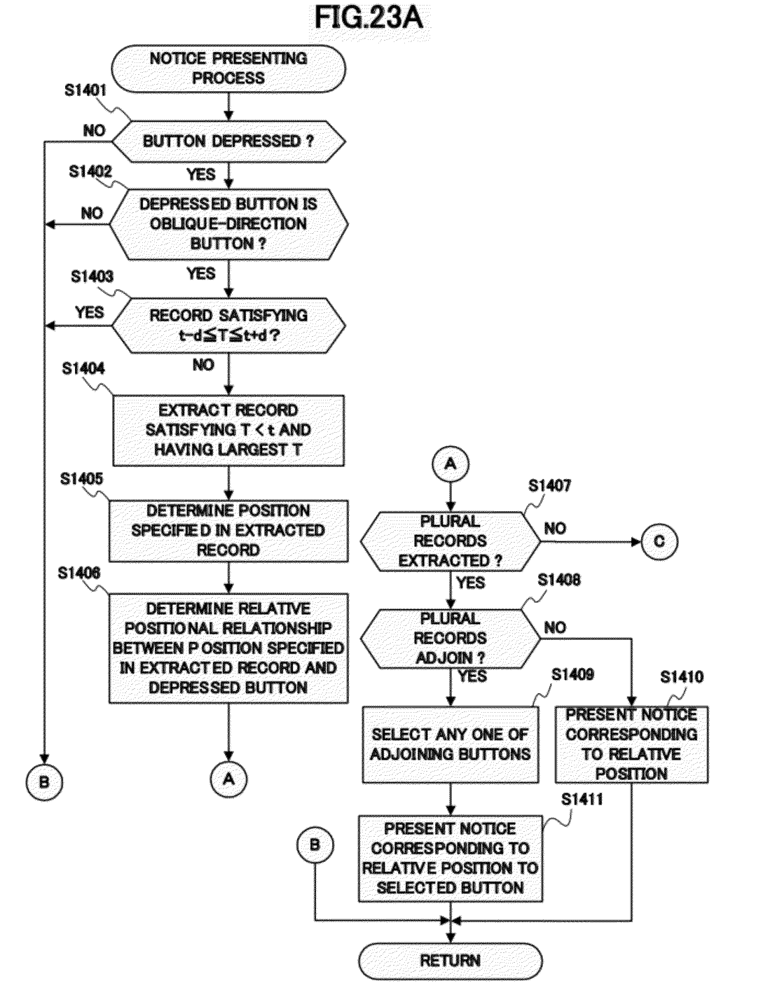

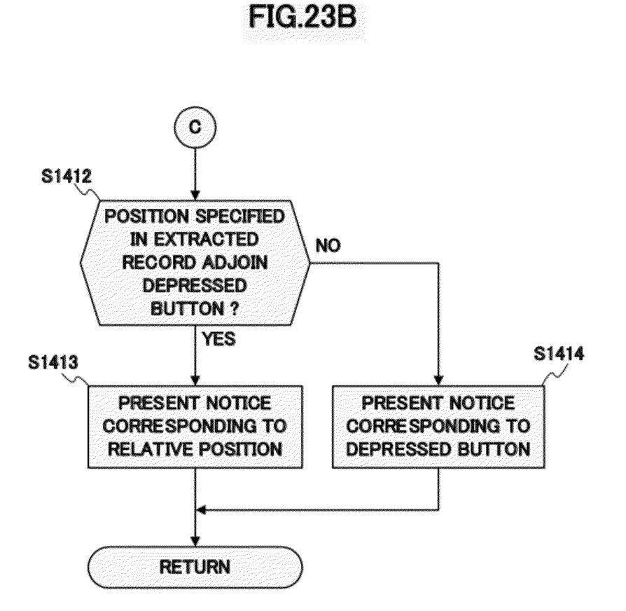

The game device 500 of the present embodiment executes the similar process as that of the flowchart of FIG. 9. However, the detail of the notice presenting process in the step S704 is different. FIGS. 23A and 23B show the detail of the notice presenting process according to the present embodiment.

First, the CPU 101 checks whether or not any one of the buttons 202 of the mat-type controller 105 is depressed (step S1401). When any one of the buttons 202 is depressed (step S1401: YES), the CPU 101 progresses the process to step S1402. Conversely, when no button 202 is depressed (step S1401: NO), the CPU 101 terminates the notice presenting process.

The CPU 101 determines in the step S1402 whether or not the depressed button 202 is the oblique-direction button 202I. When the depressed button 202 is the oblique-direction button 202I (step S1402: YES), the CPU 101 progresses the process to step S1403. Conversely, when the depressed button 202 is not the oblique-direction button 202I (step S1402: NO), the CPU 101 terminates the notice presenting process.

The CPU 101 determines in the step S1403 whether or not there is the record 402 that satisfies a condition t−d≦T≦t+d. That is, the CPU 101 determines whether or not the present screen updating number t is within the determination interval 601. When determining that there is the record 402 that satisfies a condition t−d≦T≦t+d (step S1403: YES), the CPU 101 terminates the notice presenting process. Conversely, when determining that there is no record 402 that satisfies a condition t−d≦T≦t+d (step S1403: NO), the CPU 101 extracts the record 402 which satisfies a condition T<t and which has the largest T (step S1404). That is, the CPU 101 extracts the most recent record 402 having a timing of an operation input which is indicated by the tasked time T and which has already passed.

Next, the CPU 101 determines the position that should be depressed, i.e., the kind of the button 202 indicated by the operation input kind 404 in the extracted record 402 (step S1405).

The CPU 101 determines the relative positional relationship between the kind of the button 202 which should be depressed and which is specified in the extracted record 402 and the depressed oblique-direction button 202I (step S1406). For example, when the operation input kind 404 indicated in the record 402 is the button 202P located at the “rear” of the home position HP, if the button 202D is depressed, the CPU 101 determines that the right side of the button 202P that should be depressed is depressed. According to the present embodiment, however, there is a possibility that plural records 402 are extracted.

Next, the CPU 101 determines whether or not the plurality of records 402 are extracted (step S1407). When the plurality of records 402 are not extracted (step S1407: NO), the CPU 101 progresses the process to step S1412. Conversely, when determining that the plurality of records 402 are extracted (step S1407: YES), the CPU 101 progresses the process to step S1408. The CPU 101 may present a notice corresponding to the kind of the depressed oblique-direction button 202I instead of the step S1408.

The CPU 101 determines in the step S1408 whether or not the number of buttons 202 which adjoin to the depressed oblique-direction button 202I and which should be depressed is a plural number. When the number of buttons adjoining to the oblique-direction button is not the plural number, i.e., when the number of adjoining buttons is one (step S1408: NO), the CPU 101 presents a notice message corresponding to the determined relative position (step S1410), and terminates the notice presenting process. Conversely, when the number of adjoining buttons 202 is the plural number (step S1408: YES), the CPU 101 selects any one of the adjoining buttons 202 (step S1409). The CPU 101 presents a notice corresponding to the relative position between the selected button 202 and the depressed oblique-direction button 202I (step S1411), and terminates the notice presenting process. It is fine if a preference is set in advance to either one of “back and forth” and “right and left” in the step S1409. Moreover, the CPU 101 may select the button 202 at random in the step S1409.

The CPU 101 determines in the step S1412 whether or not the button 202 that should be depressed adjoins to the depressed oblique-direction button 202I. When determining that such a button 202 adjoins to the oblique-direction button 202I (step S1412: YES), the CPU 101 presents a notice corresponding to the relative positional relationship between the button 202 which is specified in the extracted record 402 and which should be depressed and the depressed oblique-direction button 202I (step S1413), and terminates the notice presenting process.

Conversely, when determining that the button 202 does not adjoin to the oblique-direction button 202I (step S1412: NO), the CPU 101 presents a notice corresponding to the depressed position, i.e., the kind of the oblique-direction button 202I (step S1414), and terminates the notice presenting process.

According to the present embodiment, it is possible to prompt the player to correct the stepping of the improper position when the number of buttons that should be depressed is a plural number.

### Seventh Embodiment

The game device 500 of the above-explained embodiments advances the game based on an inputting of an instruction given to the mat-type controller 105. However, the game can be likewise advanced based on a depression to a touch panel in a portable information processing device including the touch panel.

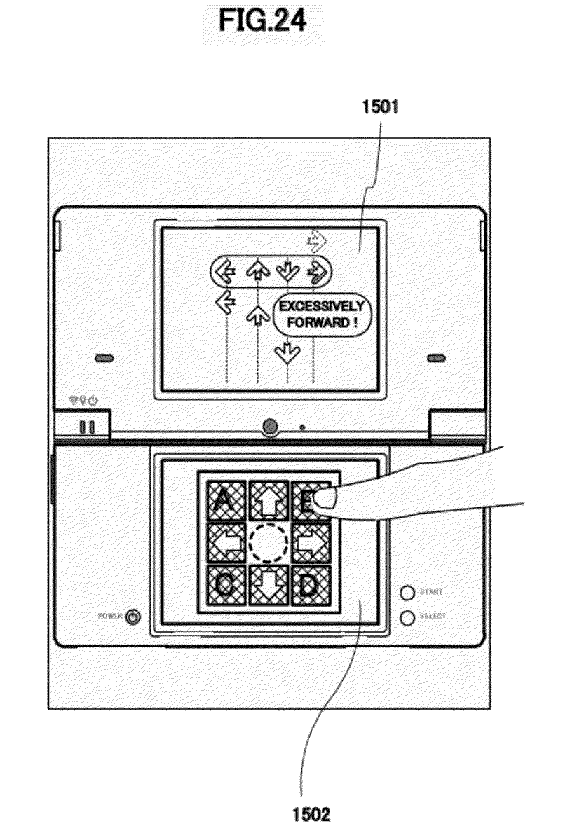

FIG. 24 shows an illustrative screen displayed by the portable information processing device. A first display unit 1501 displays the still markings 301 and the stepping-position instructing markings 302 of the above-explained embodiments. Note that respective reference numerals are omitted in the figure as needed.

Moreover, a second display unit 1502 displays the buttons 202 similar to those of the mat-type controller 105. A touch panel is disposed on the second display unit 1502 in a superimposed manner. Note that the reference numerals are omitted in the figure as needed.

The player pays an attention to the first display unit 1501 while playing the game. Hence, the player plays the game without gazing the second display unit 1502. Hence, a finger of the player is highly possibly positioned improperly. Hence, like the case in which the mat-type controller 105 is used, a function is desired which notices the improper positioning of the finger and which assists the player to depress a correct position.

For example, it is presumed that the player depresses the button 202B when it is required for the player to depress the button 202R in the most recent task. In this case, a notice message “excessively forward!” is presented in the screen. The player can perceive the mispositioning of the finger based on the presented notice message.

The portable information processing device of the present embodiment is capable of accomplishing the same function as those of the first to sixth embodiments.

According to the present embodiment, even if a touch panel is used instead of the mat-type controller, it is possible to realize a function that prompts the player to correct the improper positioning for input.

According to the present invention, there are provided a game device that is capable of prompting a player not to give an operation to a position that should not have been be operated, a control method and a non-transitory computer-readable information recording medium storing a program both for the game device.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A game device comprising:
a memory unit that stores a plurality of data of task information each indicating a timing at which a player should give an operation and a position where the operation should be given;
a display unit that displays each of the plurality of data of stored task information on a screen at least at the timing indicated in the task information;
a detecting unit which detects whether or not an operation is given by the player and which detects, when the operation is given, a position where the operation is given; and
a noticing unit that gives a notice to the player when it is detected that the player gives the operation and the detected position where the operation is given does not match any one of the positions indicated by the plurality of data of task information.

2. The game device according to claim 1, wherein the position where the operation should be given is in an operation surface, and further comprising a scoring unit that obtains a score of the player based on whether or not it is detected that the player gives the operation at the timing indicated by the task information and on whether or not the detected position where the operation is given matches a position indicated in the task information.

3. The game device according to claim 1, wherein when it is detected that the player gives an operation in a time period other than the timing indicated by the task information and the detected position where the operation is given does not match any one of the positions indicated in the plurality of data of task information, the noticing unit presents notice information to the player in order to give the notice to the player, the notice information corresponding to the detected position.

4. The game device according to claim 3, wherein the noticing unit presents the notice information to the player in order to give the notice to the player, the notice information corresponding to a relative positional relationship between the detected position and a position which is indicated by a most recent task information which has already past as indicated by the timing.

5. The game device according to claim 3, wherein when the detected position and the position which is indicated by the most recent task information which has already past as indicate by the timing
(a) adjoin to each other, the noticing unit presents the notice information to the player in order to give the notice to the player, the notice information corresponding to a relative positional relationship of the detected position to the position indicated by the most recent task information, and
(b) do not adjoin to each other, the noticing unit presents the notice information to the player in order to give the notice to the player, the notice information corresponding to the detected position.

6. The game device according to claim 5, wherein when a number of positions which adjoin to the detected position, is indicated by the most recent task information which has already past as indicated by the timing is a plural number, the noticing unit selects any one of the positions, and presents the notice information to the player in order to give the notice to the player, the notice information corresponding to the relative positional relationship of the detected position to the selected position.

7. The game device according to claim 1, wherein the noticing unit displays the notice information on the screen in order to give the notice to the player.

8. The game device according to claim 2, wherein
the operation surface is provided with a plurality of detectors which are disposed on the operation surface and which detect a depression given by the player,
the positions indicated by the plurality of data of task information are all any positions of the plurality of detectors,
the positions of the plurality of detectors include positions which are not the positions indicated by the plurality of data of task information, and
when any one of the plurality of detectors is depressed, the detecting unit detects a depressed timing and the position of the depressed detector as the timing at which the operation is given and the position where the operation is given.

9. The game device according to claim 2, wherein
the operation surface is a touch panel that detects a depression given by the player, and
the detecting unit detects a timing at which the depression is given to the touch panel and a position where the depression is given as the timing at which the operation is given and the position where the operation is given.

10. A control method for a game device including a memory unit to store a plurality of data of task information each indicating a timing at which a player should give an operation and a position where the operation should be given, the method comprising:
displaying each of the plurality of data of stored task information on a screen at least at the timing indicated in the task information;
detecting whether or not an operation is given by the player and also to detect, when the operation is given, a position where the operation is given; and
giving a notice to the player when it is detected that the player gives the operation and the detected position where the operation is given does not match any one of the positions indicated by the plurality of data of task information.

11. A non-transitory computer-readable information recording medium storing a program that causes a computer to function as:
a memory unit that stores a plurality of data of task information each indicating a timing at which a player should give an operation and a position where the operation should be given;
a display unit that displays each of the plurality of data of stored task information on a screen at least at the timing indicated in the task information;
a detecting unit which detects whether or not an operation is given by the player and which detects, when the operation is given, a position where the operation is given; and
a noticing unit that gives a notice to the player when it is detected that the player gives the operation and the detected position where the operation is given does not match any one of the positions indicated by the plurality of data of task information.
